(19) United States
(12) Patent Application Publication
(10) Pub. No.: US 2006/0258556 A1
(43) Pub. Date: Nov. 16, 2006

(54) Detergent tablets having an optimized shape

(76) Inventors: Thomas Holderbaum, Monheim (DE); Eckhard Von Eysmondt, Langenfeld (DE); Achim Kempf, Koeln (DE); Uta Steffen-Holderbaum, Koeln (DE)

Correspondence Address: DANN DORFMAN HERRELL AND SKILLMAN;A PROFESSIONAL CORPORATION, 1601 MARKET STREET, SUITE 2400, PHILADELPHIA, PA, 19103-2307, US

(21) Appl. No.: 11/235,956

(22) Filed: Sep. 26, 2005

Related U.S. Application Data
(63) Continuation of application No. PCT/EP04/02718, filed on Mar. 17, 2003.

(30) Foreign Application Priority Data
Mar. 25, 2003 (DE) DE 103 13 172.8

(51) Int. Cl. C11D 17/00

(52) U.S. Cl. 510/447

(57) ABSTRACT

A spatially optimized form of detergent tablets, which is provided with the greatest possible volume while being useable in the largest possible number of dosing chambers of known dishwashers available on the European market. Said detergent tablets comprise a bottom surface and a top surface. The places of the two surfaces are not parallel across at least half of the size of the smaller surface.

### CROSS-REFERENCE TO RELATED APPLICATIONS

This application is a continuation under 35 U.S.C. § 365(c) and 35 U.S.C. § 120 of international application PCT/EP 2004/002718, filed Mar. 17, 2004. This application also claims priority under 35 U.S.C. § 119 of DE 103 13 172.8, filed Mar. 25, 2003, which is incorporated herein by reference in its entirety.

### (c) STATEMENT REGARDING FEDERALLY SPONSORED RESEARCH OR DEVELOPMENT

Not Applicable

### (d) INCORPORATION-BY-REFERENCE OF MATERIAL SUBMITTED ON A COMPACT DISC

Not Applicable

### (e) BACKGROUND OF THE INVENTION

(1) Field of the Invention

The present invention relates to laundry detergent or cleaning composition tablets which have an optimized shape. In particular, the present invention relates to cleaning composition tablets for machine dishwashing which are used in domestic machine dishwashers.

The machine cleaning of dishware in domestic machine dishwashers typically comprises a prewash cycle, a main wash cycle and a rinse cycle, the latter being interrupted by intermediate wash cycles. In some programs in the usually higher-cost machines, the prewash cycle can be selected for highly soiled dishware or is automatically selected by means of particular turbidity sensors. However, the consumer generally selects normal programs without prewash cycle, so that a main wash cycle, an intermediate wash cycle with clean water and a rinse cycle are carried out in most cases.

Typically, in the main wash cycle, water is admitted into the interior of the machine and circulated, in the course of which the water is heated. After a few minutes, the dispenser cup of the machine is opened and releases the contents which dissolve in the warmed water. Compositions are available on the market which are not intended to be or cannot be dispensed by means of the dispenser cup. These compositions cannot be used together with a prewash cycle, since too much of the composition is dissolved in the prewash cycle and pumped out of the machine. If the composition is correspondingly formulated so as to be more sparingly soluble, the result may be solubility problems in the main wash cycle and thus worsened cleaning results. Modern compositions which are also usable in conjunction with a prewash program therefore still have to be dispensable by means of the dispenser cup.

On the other hand, the space within the dispenser cup is restricted owing to ecological considerations of the dishwasher manufacturer or simply for reasons of space. The trend in the last few years has therefore been toward increasing compression of the ingredients in order to be able to bring a maximum amount of cleaning composition into the main wash cycle. Highly compressed cleaning composition tablets in the machine dishwashing sector therefore already have market shares far above 80% of the total detergent market in some countries.

However, the increasing compression leads to other problems, since, although the hardness and thus also the ease of handling of the tablets increases with increasing compression pressure thereof, their solubility decreases significantly. Thus, particularly hard tablets can dissolve only at a later stage, which leads to the active substances going into solution only at a later stage and hence being available for a shorter time in the cleaning process, and thus to a deterioration in the cleaning result.

While a maximum degree of compression is required for a maximum dosage, the hardness (and hence indirectly also the density) of the tablets has to be selected at a minimum level for a sufficient solubility. This leads to the corresponding moldings, for the same volume, containing less cleaning composition which is available for the cleaning performance. At a given volume of the dispenser cup, the available space therefore has to be utilized to a maximum degree.

These problems are intensified by the need for a product to be usable in a wide variety of different machine dishwashers. Since the shape of the dispenser cup is not standardized, each manufacturer of machine dishwashers has its own design which differs from that of another manufacturer with regard to shape and contents. Since the lifetime of machine dishwashers can additionally, depending on the workload, quite possibly be several decades, and the dispenser chambers of a manufacturer can also differ from model to model or from model year to model year, the “lowest common denominator” often has to be sought in order to ensure that a cleaning composition fits into the dispenser drawers of the most important dishwashers on the particular market.

Especially with regard to the reduction of the density in the case of rapid-solubility tablets, a maximum utilization of space is therefore desired without at the same time generating the aforementioned problems of inadequate insertability into the dispenser chambers.

(2) Description of Related Art Including Information Disclosed Under 37 C.F.R. §§ 1.97 and 1.98.

Not Applicable (f)

### BRIEF SUMMARY OF THE INVENTION

Therefore an object of the present invention to provide a space-optimized supply form for laundry detergents or cleaning compositions, which has a maximum volume and at the same time can be inserted into a maximum number of dispenser chambers of the machine dishwashers available on the European market.

It has now been found that tablets which combine a maximum volume and a precision fit into a maximum number of metering chambers do not have plane-parallel upper and lower sides.

In a first embodiment, the present invention provides laundry detergent or cleaning composition tablets which have a bottom face and a top face, the two faces not being plane-parallel over at least half of the size of the smaller face.

Depending on the shape of the base, the laundry detergent or cleaning composition tablets customary on the market have three or six faces. A cylindrical tablet has an upper side and a lower side (referred to in the context of the present invention as top face and bottom face respectively) and a cylindrical shell as a vertical limiting face. When the base is rectangular, there exist four lateral limiting faces. Customary tablets have plane-parallel upper and lower sides, i.e. have a cylindrical or tetragonal shape. In the context of the present invention, the bottom face and the top face are at least partly tilted relative to one another, which removes the plane-parallelism.

An inventive tablet may therefore have, for example, a horizontal planar bottom face and a planar top face at an oblique angle of, for example, 50 relative thereto. Since the top face then has a larger size (its length is greater than that of the bottom face), a reference point (the smaller face) has been selected in accordance with the invention in order to be able to describe such embodiments which, unlike in the above example, have bottom faces or top faces which are only partly not plane-parallel, i.e. also have plane-parallel sections.

This section of plane-parallelism of bottom face and top face in inventive tablets is, though, preferably less than 50%. Preference is given here to laundry detergent or cleaning composition tablets in which the bottom face and top face are not plane-parallel over at least 60%, preferably over at least 70%, particularly preferably over at least 80%, more preferably over at least 90% and in particular over the entire size of the smaller face.

In the aforementioned example, the non-plane-parallelism was achieved by the top face being “tilted” relative to the bottom face, the two faces still being entirely planar. However, non-plane-parallelism can also be achieved in accordance with the invention by one (or both) face(s) not being planar. For example, it is also possible to provide curved faces or faces with relief structures, for example wave patterns, as the bottom face and/or top face.

Non-plane-parallelism would also be achievable, for example, by both the bottom face and the top face having a concave or convex structure, or one of the two faces having a planar structure while the other has a concave or convex structure. Such tablet shapes are explicitly not preferred in accordance with the invention. Accordingly, inventive tablets are preferably not configured with a planar-convex, planar-concave, biconvex, biconcave, convex-concave face configuration.

It is preferred that the bottom face is planar to an extent of at least 50%, preferably to an extent of at least 60%, particularly preferably to an extent of at least 70%, more preferably to an extent of at least 80%, very particularly preferably to an extent of at least 90% and in particular over the whole face.

When the inventive laundry detergent or cleaning composition tablets have beveled (chamfered) edges, which is preferred, the entire bottom face or top face is strictly speaking not planar. However, the beveled edge is preferably configured in such a way that the facet makes up only a maximum of 10% of the size of the bottom face or top face. A 100% planar bottom face or top face is thus realizable only when the facet is dispensed with.

Analogously, preference is given to inventive laundry detergent or cleaning composition tablets in which the top face is planar to an extent of at least 35%, preferably to an extent of at least 60%, particularly preferably to an extent of at least 70%, more preferably to an extent of at least 80%, very particularly preferably to an extent of at least 90% and in particular over the whole face.

As already mentioned above, concave and convex top faces are not preferred. However, one alternative to entirely planar top faces is that of curved faces in which the curvature runs only in one cutting plane (for example in the longitudinal cut). These differ from convex and concave faces and constitute further preferred embodiments of the invention in addition to the planar faces.

The combination of the (substantially) planar bottom face with the (substantially) planar bottom face leads to faces tilted (at least partly) relative to one another, as in the example cited at the outset. In the case of such “tilted” faces, preference is given to inventive laundry detergent or cleaning composition tablets in which the non-plane-parallel proportions of the bottom face and top face enclose with one another an angle of from 1° to 50°, preferably from 1.5° to 30°, particularly preferably from 2° to 25°, more preferably from 2.5° to 20° and in particular from 3° to 15°.

Inventive laundry detergent or cleaning composition tablets of the above-described type have vertical lateral limiting faces. As a result of conventional tableting technology, in which a die is charged and the charge is compressed by means of a punch, vertical limiting faces are state of the art. It would not be possible to tablet undercuts, since it would not be possible to expel the finished tablet upward out of the die. However, it is possible to select the bottom face of the die so as to be smaller than the pressing face of the punch, especially of the upper punch, and hence to impart to the tablet at least partly nonvertical lateral limiting faces. This may be desired for further shape optimization but makes the tableting somewhat more complex.

Preferred inventive laundry detergent or cleaning composition tablets are characterized in that at least one lateral limiting face which connects bottom face and top face is nonvertical over at least 60%, preferably over at least 70%, particularly preferably over at least 75% and in particular over at least 80%, of its height.

In the case of tablets having only one lateral limiting face (bottom face and top face have the shape of a circle, an ellipse, etc), this variant can be envisaged in such a way that a frustocone standing on its “head” is obtained. The shape of the inventive moldings is preferably selected in such a way that it has at least two lateral limiting faces. At least two lateral limiting faces can be achieved, for example, by the above-described frustoconical tablet being divided perpendicularly into two halves. The resulting bodies in turn have an upper side and lower side and also two lateral limiting faces (a semicircular cylindrical shell and a perpendicular side face which is rectangular in plan view). In order to obtain a preferred inventive molding in this example, the frustoconical tablet would have to be divided obliquely, i.e. the cutting plane would deviate from the vertical. As a result of this, the side face which is rectangular in plan view is tilted relative to the perpendicular to the horizontal and is accordingly no longer vertical.

It is not necessary for this embodiment preferred in accordance with the invention that the entire limiting face is not vertical. In fact, certain vertical sections do not lead away from the inventive advantages. In the abovementioned example, a “half-disk” from the vertically divided frustocone might therefore be situated on the frustocone divided obliquely in accordance with the invention. When both frusta have the same height beforehand, exactly half of the lateral limiting face is vertical, while the other half is not vertical. The height of the lateral limiting face is consequently the distance between upper side and lower side and hence equal to the height of the molding. This height is independent of the inclination of the lateral limiting face relative to the vertical: while the length of the line that has to be traveled from the upper side to the lower side on the lateral limiting face increases with decreasing angle between the horizontal and the lateral face, the height remains the same. The vertical and nonvertical proportions of the height can be determined by perpendicular formation to the vertical (height) and determination of the particular proportion of the total height. It will be appreciated that it is possible in accordance with the invention to configure a side face in such a way that it first has a vertical section, then a nonvertical section which merges in turn into a vertical section. In the case of tablets, this may even be distinctly preferred for production and stability reasons. Especially for production reasons, it is preferred that inventive tablets with at least partly nonvertical lateral limiting face have a vertical section which adjoins the top face. This vertical section allows the tablet punch to introduce at least a small part into the die which narrows in the downward direction.

The at least one nonvertical lateral limiting face encloses an angle α with the horizontal. Since the nonvertical lateral limiting face tilts “outward” (i.e. the molding becomes broader toward the top), this angle is below 90°. Preference is given in accordance with the invention to a nonvertical limiting face which encloses an angle with the horizontal which deviates by at least approx. 5-10° from a right angle. Particularly preferred inventive laundry detergent or cleaning composition tablets are characterized in that one lateral limiting face is not vertical over at least half of its height and encloses an angle with the horizontal of from 30° to 80°, preferably from 35° to 75°, more preferably from 40° to 70° and in particular from 50° to 60°.

Preferred values of the angle α are, for example, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64° or 65°. Particularly preferred values in this context are 48°, 49°, 50°, 51°, 52°, or noninteger values between these integer values.

Depending on the shape of the horizontal limiting faces, the shape and number of the side faces of the inventive moldings may vary. It will be appreciated that it is also possible for the upper and lower limiting face to have different basic shapes. With regard to the aim of the present invention, of realizing maximum space utilization, preference is, however, given to rectangular bottom and top faces. For esthetic and/or mechanical reasons, these may quite possibly have rounded corners. The roundings may in turn be derived from circular sections whose radii may preferably be between 5 and 15% of the height of the molding. Two rectangular bottom and top faces give rise to four lateral limiting faces.

In the preferred inventive laundry detergent or cleaning composition tablets with rectangular bottom and top faces, only one lateral limiting face can be nonvertical over at least half its height. When two lateral limiting faces are nonvertical over at least half of their height, these nonvertical side faces may be opposite one another. When the two nonvertical side faces touch one another, they are in an L-shape.

Preferred inventive laundry detergent or cleaning composition tablets have four lateral limiting faces of which one is nonvertical over at least half of its height.

As already mentioned, for reasons of mechanical stability or esthetics, the corners of the inventive laundry detergent or cleaning composition tablets may be rounded off. Edges may also have a chamfer, i.e. be beveled. The radius of one corner bevel is preferably a maximum of 1/10 of the length of the shortest side which adjoins the corner. In the case of edges with a chamfer, the width of the chamfer is preferably a maximum of 1/10 of the width of the narrower side meeting this edge. In summary, preference is given to inventive laundry detergent or cleaning composition tablets in which the corners of the molding are rounded off. Particular preference is further given to laundry detergent or cleaning composition tablets which are characterized in that the edges of the molding have a chamfer.

The inventive laundry detergent or cleaning composition tablets preferably have a height of from 10 to 30 mm. Particularly preferred inventive laundry detergent or cleaning composition tablets have, for example, heights of 12, 13, 14, 15, 16, 17, 18, 19, 20, 21, 22, 23 or 24 mm, or values between these integer values. The length of the inventive moldings is preferably between 25 and 60 mm, more preferably between 30 and 55 mm. Mention should be made here by way of example of particularly preferred lengths of 32 mm, 33 mm, 34 mm, 35 mm, 36 mm, 37 mm, 38 mm, 39 mm, 40 mm, 41 mm or 42 mm, and it is also possible for the values to lie between these integer values.

The maximum width of the inventive laundry detergent or cleaning composition tablets, i.e. the width of the larger face of bottom or top face, is preferably from 20 to 60 mm, more preferably from 25 to 50 mm. Mention should be made here by way of example of particularly preferred widths of 30 mm, 31 mm, 32 mm, 33 mm, 34 mm, 35 mm, 36 mm, 37 mm, 38 mm, 39 mm, 40 mm, 41 mm or 42 mm, and the values may also lie between these integer values.

In preferred embodiments of the present invention, the inventive laundry detergent or cleaning composition tablets have a high specific weight. Preference is given in accordance with the invention to laundry detergent and cleaning composition tablets which are characterized in that they have a density above 1000 kgm⁻³, preferably above 1025 kgm³, more preferably above 1050 kgm⁻³, and in particular above 1100 kgm⁻³. The process of tableting is illustrated below:

It has been found to be advantageous when the premixture to be compressed to tablets fulfills certain physical criteria. Preferred tableting processes are, for example, characterized in that the particulate premixture has a bulk density of at least 500 g/l, preferably at least 600 g/l and in particular at least 700 g/l.

The particle size of the compressed premixture preferably also fulfills certain criteria: preference is given in accordance with the invention to processes in which the particulate premixture has particle sizes between 100 and 2000 μm, preferably between 200 and 1800 μm, more preferably between 400 and 1600 μm and in particular between 600 and 1400 μm. To establish advantageous molding properties, a further narrowed particle size may be established in the premixtures to be compressed. In preferred tableting processes, the compressed particulate premixture has a particle size distribution in which fewer than 10% by weight, preferably fewer than 7.5% by weight and in particular fewer than 5% by weight of the particles are larger than 1600 μm or smaller than 200 μm.

In this context, preference is further given to narrower particle size distributions. Particularly advantageous process variants are characterized in that the compressed particulate premixture has a particle size distribution in which more than 30% by weight, preferably more than 40% by weight and in particular more than 50% by weight of the particles have a particle size between 600 and 1000 μm.

In the performance of the tableting, there is no restriction merely to compressing a particulate premixture to a molding. Rather, the process can also be extended to the production of multilayer moldings in a manner known per se by preparing two or more premixtures which are compressed onto one another. In this case, the premixture introduced first is lightly precompressed in order to obtain a smooth upper side running parallel to the molding bottom, and end-compressed to the finished molding after the second premixture has been introduced. In the case of three-layer or multilayer moldings, there is a further precompression after each premixture addition, before the molding is end-compressed after addition of the last premixture.

Such different layers can be utilized firstly for the separation of incompatible ingredients and secondly for the visualization of individual functionalities. Particularly preferred inventive laundry detergent or cleaning composition tablets are therefore characterized in that they have a multiphase, in particular multilayer, structure.

The inventive moldings are produced initially by the dry mixing of the constituents which may be fully or partly pregranulated, and subsequent shaping, in particular compression, to tablets, for which conventional processes can be employed. To produce the inventive moldings, the premixture is compacted in a die between two punches to form a solid compact. This operation, which is referred to below as tableting for short, divides into four sections: metering, compaction (elastic reshaping), plastic reshaping and expulsion.

First, the premixture is introduced into the die, the fill level and thus the weight and the shape of the resulting molding being determined by the position of the lower punch and the shape of the compression tool. Even in the case of high molding throughputs, the uniform metering is preferably achieved by volumetric metering of the premixture. In the further course of tableting, the upper punch contacts the premixture and descends further in the direction of the lower punch. In the course of this compaction, the particles of the premixture are pressed closer to one another, in the course of which the depression volume within the filling between the punches decreases continuously. From a certain position of the upper punch (and thus from a certain pressure on the premixture), plastic reshaping begins, in the course of which the particles coalesce and the molding is formed. Depending on the physical properties of the premixture, a portion of the premixture particles is also crushed and there is sintering of the premixture at even higher pressures. At increasing compression rate, i.e. high throughput amounts, the phase of elastic reshaping is shortened ever further, so that the resulting moldings can have cavities of greater or lesser size. In the last step of the tableting, the finished molding is pushed out of the die by the lower punch and conveyed away by downstream transport devices. At this time, only the weight of the molding has been ultimately defined, since the compacts may still change their shape and size owing to physical processes (elastic relaxation, crystallographic effects, cooling).

The tableting is effected in customary tableting presses which may in principle be equipped with single or double punches. In the latter case, not only the upper punch is used for pressure buildup; the lower punch also moves toward the upper punch during the compaction operation, while the upper punch presses downward. For small production amounts, preference is given to using eccentric tableting presses in which the punch(es) is/are secured to an eccentric disk which is in turn mounted on an axle having a particular rotation rate. The movement of these compression punches is comparable to the way in which a typical four-stroke engine works. The compression can be effected with one upper and one lower punch, but a plurality of punches may also be secured to one eccentric disk, in which case the number of die bores is increased correspondingly. The throughputs of eccentric presses vary by type from a few hundred to a maximum of 3000 tablets per hour.

For greater throughputs, rotary tableting presses are selected, in which a greater number of dies is arranged in a circle on what is known as a die table. The number of dies varies by model between 6 and 55, larger dies also being commercially available. An upper and lower punch is assigned to each die on the die table, and the compression pressure can again be built up actively only by the upper or lower punch, or else by both punches. The die table and the punches move about a common vertical axis, the punches being brought into the positions for filling, compaction, plastic reshaping and expulsion with the aid of rail-like cam tracks during the rotation. At the points at which particularly severe raising or lowering of the punches is required (filling, compaction, expulsion), these cam tracks are supported by additional low-pressure sections, low-tension rails and discharge tracks. The dies are filled by means of a rigidly mounted feed apparatus, known as the filling shoe, which is connected to a stock vessel for the premixture. The compression pressure on the premixture can be adjusted individually by means of the compression paths for upper and lower punch, in which case the pressure is built up by virtue of the rolling movement of the punch shaft heads past adjustable pressure rolls.

To increase the throughput, rotary presses may also be provided with two filling shoes, in which case only one half-circle has to be passed through to produce one tablet. To produce two-layer and multilayer tablets, a plurality of filling shoes are arranged in series, without the lightly pressed first layer being expelled before the further filling. Suitable process control makes it possible in this way also to produce coated tablets and inlay tablets which have an onion-like structure, the top face of the core or of the core layers in the case of the inlay tablets not being covered and thus remaining visible. Rotary tableting presses can also be equipped with single or multiple tools, so that, for example, an outer circle having 50 bores and an inner circle having 35 bores may be utilized simultaneously for compression. The throughputs of modern rotary tableting presses are more than one million tablets per hour.

In the case of tableting with rotary presses, it has been found to be advantageous to carry out the tableting with minimum weight variations of the tablet. In this way, it is also possible to reduce the hardness variations of the tablet. Small weight variations can be achieved in the following manner:

use of plastic inlays having low thickness tolerances;

low rotation rate of the rotor;

large filling shoe;

adjustment of the filling shoe vane rotation rate to the rotation rate of the rotor;

filling shoe with constant powder height; and

decoupling of filling shoe and powder reservoir.

To reduce caking on the punches, it is possible to use any antiadhesion coatings known from the art. Particularly advantageous antiadhesion coatings are plastic coatings, plastic inlays or plastic punches. Rotary punches have also been found to be advantageous, and upper and lower punch should be configured in a rotatable manner if possible. In the case of rotating punches, it is generally possible to dispense with a plastic inlay. In this case, the punch surfaces should be electropolished.

It has also been found that long pressing times are advantageous. These may be attained with pressure rails, a plurality of pressure rolls or low rotor rotation rates. Since the hardness variations of the tablet can be caused by the variations in the pressing forces, systems should be employed which restrict the pressing force. It is possible here to use elastic punches, pneumatic compensators or sprung elements in the force path. The pressure roll may also be of sprung design.

Tableting processes preferred in the context of the present invention are characterized in that the compression is effected at compression pressures of from 0.01 to 50 kNcm⁻², preferably from 0.1 to 40 kNcm⁻² and in particular from 1 to 25 kNcm⁻².

Tableting machines suitable in the context of the present invention are, for example, obtainable from Apparatebau Holzwarth GbR, Asperg, Wilhelm Fette GmbH, Schwarzenbek, Hofer GmbH, Weil, Horn & Noack Pharmatechnik GmbH, Worms, IMA Verpackungssysteme GmbH Viersen, KILIAN, Cologne, KOMAGE, Kell am See, KORSCH Pressen AG, Berlin, and Romaco GmbH, Worms. Further suppliers are, for example, Dr. Herbert Pete, Vienna (AU), Mapag Maschinenbau AG, Berne (CH), BWI Manesty, Liverpool (GB), I. Holand Ltd., Nottingham (GB), Courtoy N.V., Halle (BE/LU) and Mediopharm Kamnik (SI). A particularly suitable tableting press is, for example, the HPF 630 hydraulic double-pressure press from LAEIS, Germany. Tableting tools are available, for example, from Adams Tablettierwerkzeuge, Dresden, Wilhelm Fett GmbH, Schwarzenbek, Klaus Hammer, Solingen, Herber & Söhne GmbH, Hamburg, Hofer GmbH, Weil, Horn & Noack, Pharmatechnik GmbH, Worms, Ritter Pharmatechnik GmbH, Hamburg, Romaco, GmbH, Worms and Notter Werkzeugbau, Tamm. Further suppliers are, for example, Senss AG, Reinach (CH) and Medicopharm, Kamnik (SI).

One possible further means of producing multiphase tablets is to configure the inventive tablets with a cavity and to fill the cavity in a later working step with a liquid, a powder, a granule, extrudate, etc. Particularly preferred, and established in the prior art, is the introduction of a further molding, preferably of a tablet, into the cavity.

In the context of the present invention, the term “cavity” denotes both depressions and holes which pass through the molding and connect bottom and top face.

Particularly preferred inventive laundry detergent or cleaning composition tablets are characterized in that the top face has at least one cavity into which a separately produced molding can be introduced.

The shape of the cavity, which is preferably a depression, may be selected freely, preference being given to tablets in which at least one depression may assume a concave, convex, cubic, tetragonal, orthorhombic, cylindrical, spherical, cylinder segment-like, disk-shaped, tetrahedral, dodecahedral, octahedral, conical, pyramidal, ellipsoidal, pentagonally, heptagonally and octagonally prismatic, and rhombohedral shape. It is also possible to realize entirely irregular depression shapes such as arrow or animal shapes, trees, clouds, etc. As in the case of the base moldings, preference is given to depressions having rounded corners and edges or having rounded corners and chamfered edges.

The separate molding to be introduced into the depression is preferably a smaller, separately produced tablet which is inserted into the depression and bonded securely to it, which can be achieved, for example, by clip- or form-fitting or by an adhesive bond. The separately produced molding preferably itself has a top face which is not entirely planar. The bottom face of the separately produced molding is not of quite such great importance since it is hidden invisibly in the cavity, unless the cavity is a penetrating hole and the separately produced molding can be seen from both sides.

Preferred inventive laundry detergent or cleaning composition tablets are characterized in that the separately produced molding has a top face which is not entirely planar.

The incomplete planarity of the separately produced molding, unlike for the inventive tablets themselves, is achieved by a convex curvature. The edge of this convex curvature is more preferably planar, i.e. the surface which connects all points on the edge to one another is planar. Most preferably, the planar edge is aligned so as to be parallel to the bottom face of the base tablets. In summary, preference is given to inventive laundry detergent or cleaning composition tablets in which the top face of the separately produced molding has convex curvature, the edge of the top face of the separately produced molding preferably being aligned parallel to the bottom face of the laundry detergent or cleaning composition tablets.

There follows a description of the preferred ingredients of the inventive laundry detergent or cleaning composition tablets.

Particular preference is given to washing and cleaning substances from the group of bleaches, bleach activators, polymers, builders, surfactants, enzymes, disintegrants, electrolytes, pH modifiers, fragrances, perfume carriers, dyes, hydrotropes, foam inhibitors, antiredeposition agents, optical brighteners, graying inhibitors, shrink preventatives, anticrease agents, dye transfer inhibitors, antimicrobial active ingredients, germicides, fungicides, antioxidants, corrosion inhibitors, antistats, repellency and impregnation agents, swelling and antislip agents, nonaqueous solvents, fabric softeners, protein hydrolyzates and UV absorbers.

As important constituents of laundry detergents and cleaning compositions, bleaches and bleach activators may be present in the inventive compositions in addition to other constituents. Among the compounds which serve as bleaches and supply H₂O₂ in water, sodium percarbonate and also sodium perborate tetrahydrate and sodium perborate monohydrate are of particular significance. Further bleaches which can be used are, for example, peroxypyrophosphates, citrate perhydrates, and H₂O₂-supplying peracidic salts or peracids, such as perbenzoates, peroxophthalates, diperazelaic acid, phthaloimino peracid or diperdodecanedioic acid. Detergent tablets for machine dishwashing may also comprise bleaches from the group of the organic bleaches. Typical organic bleaches are the diacyl peroxides, for example dibenzoyl peroxide. Further typical organic bleaches are the peroxy acids, particular examples being the alkyl peroxy acids and the aryl peroxy acids. Preferred representatives are (a) the peroxybenzoic acids and ring-substituted derivatives thereof, such as alkylperoxybenzoic acids, but it is also possible to use peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxy-hexanoic acid (PAP)], o-carboxybenzamidoperoxycaproic acid, N-nonenylamidoperadipic acid and N-nonenylamido-persuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid and N,N-terephthaloyldi(6-aminopercaproic acid).

When the inventive compositions are used as machine dishwasher detergents, they may comprise bleach activators in order to achieve improved bleaching action in the course of cleaning at temperatures of 60° C. and below. Bleach activators which may be used are compounds which, under perhydrolysis conditions, give aliphatic peroxocarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified, and/or optionally substituted benzoyl groups. Preference is given to polyacylated alkylenediamines, in particular tetra-acetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran.

Further bleach activators used with preference in the context of the present application are compounds from the group of cationic nitriles, in particular cationic nitrile of the formula 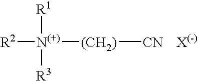
in which R¹ is —H, —CH₃, a C₂₋₂₄-alkyl or -alkenyl radical, a substituted C₂₋₂₄-alkyl or -alkenyl radical having at least one substituent from the group of —Cl, —Br, —OH, —NH₂, —CN, an alkyl- or alkenylaryl radical with a C₁₋₂₄-alkyl group, or is a substituted alkyl- or alkenylaryl radical having a C₁₋₂₄-alkyl group and at least one further substituent on the aromatic ring, R² and R³ are each independently selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH where n=1, 2, 3, 4, 5 or 6 and X is an anion.

Particularly preferred inventive compositions comprise a cationic nitrile of the formula 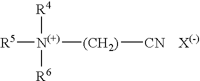
in which R⁴, R⁵ and R⁶ are each independently selected from —CH₃, —CH₂—CH₃, —CH₂—CH₂—CH₃, —CH(CH₃)—CH₃, where R⁴ may additionally also be —H and X is an anion, where preferably R⁵=R⁶=—CH₃ and in particular R⁴=R⁵=R⁶=—CH₃, particular preference being given to compounds of the formulae (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CH(CH₃))₃N⁽⁺⁾CH₂—CN X⁻, or (HO—CH₂—CH₂)₃N⁽⁺⁾CH₂—CN X⁻, particular preference from the group of these substances being given in turn to the cationic nitrile of the formula (CH₃)₃N⁽⁺⁾CH₂—CN X⁻ in which X⁻ is an anion which is selected from the group of chloride, bromide, iodide, hydrogensulfate, methosulfate, p-toluenesulfonate (tosylate) or xylenesulfonate.

In addition to the conventional bleach activators or in their stead, it is also possible to incorporate bleach catalysts into the compositions. These substances are bleach-boosting transition metal salts or transition metal complexes, for example salen or carbonyl complexes of Mn, Fe, Co, Ru or Mo. It is also possible to use Mn, Fe, Co, Ru, Mo, Ti, V and Cu complexes with N-containing tripod ligands, and also Co-, Fe-, Cu- and Ru-amine complexes as bleach catalysts.

In the case of the surfactants, especially useful are the anionic surfactants in acid form, aqueous solutions or pastes of the neutralized anionic surfactant acids, nonionic surfactants and/or cationic surfactants, or amphoteric surfactants. Depending on the selection of the surfactant(s) used, surfactant-containing inventive compositions can be used, for example, in the removal of grease or oil stains, their field of use ranging from textile cleaning to the removal of oil contamination outdoors. In the context of the present application, depending on the field of use, preference is given to laundry detergent or cleaning composition tablets which have a surfactant content of from 1 to 70% by weight, more preferably from 2 to 60% by weight, especially preferably from 4 to 50% by weight, based in each case on the total weight of the compositions.

In addition to the bleach and bleach activator ingredients mentioned, builders are further important ingredients of laundry detergent or cleaning compositions. Preferred inventive compositions may comprise all builders customarily used in cleaning compositions, i.e. especially zeolites, silicates, carbonates, organic cobuilders and, where there are no ecological objections to their use, also the phosphates.

Suitable crystalline, sheet-type sodium silicates have the general formula NaMSiₓO₂ₓ₊₁.H₂O where M is sodium or hydrogen, x is a number from 1.9 to 4, y is a number from 0 to 20, and preferred values for x are 2, 3 or 4. Preferred crystalline sheet silicates of the formula specified are those in which M is sodium and x assumes the values 2 or 3. In particular, preference is given to both β- and also δ-sodium disilicates Na₂Si₂O₅.yH₂O.

It is also possible to use amorphous sodium silicates having an Na₂O:SiO₂ modulus of from 1:2 to 1:3.3, preferably from 1:2 to 1:2.8 and in particular from 1:2 to 1:2.6, which have retarded dissolution and secondary washing properties. The retardation of dissolution relative to conventional amorphous sodium silicates may have been brought about in a variety of ways, for example by surface treatment, compounding, compacting or by overdrying. In the context of this invention, the term “amorphous” also includes “X-ray-amorphous”. This means that, in X-ray diffraction experiments, the silicates do not afford any sharp X-ray reflections typical of crystalline substances, but rather yield at best one or more maxima of the scattered X-radiation, which have a width of several degree units of the diffraction angle. However, it may quite possibly lead to even particularly good builder properties if the silicate particles in electron diffraction experiments yield vague or even sharp diffraction maxima. This is to be interpreted such that the products have microcrystalline regions with a size of from 10 to several hundred nm, and preference is given to values up to a maximum of 50 nm and in particular up to a maximum of 20 nm. Such X-ray-amorphous silicates likewise have retarded dissolution compared with conventional waterglasses. Particular preference is given to compacted amorphous silicates, compounded amorphous silicates and overdried X-ray-amorphous silicates.

The finely crystalline synthetic zeolite containing bound water which can be used is preferably zeolite A and/or P. The zeolite P is more preferably Zeolite MAP® (commercial product from Crosfield). Also suitable, however, are zeolite X, and mixtures of A, X and/or P. Also commercially available and usable in accordance with the invention is, for example, a cocrystal of zeolite X and zeolite A (about 80% by weight of zeolite X), which is sold by CONDEA Augusta S.p.A. under the trade name VEGOBOND AX® and can be described by the formula
nNa₂O.(1-n)K₂O.Al₂O₃.(2-2.5)SiO₂.(3.5-5.5)H₂O.
Suitable zeolites have an average particle size of less than 10 μm (volume distribution; measurement method: Coulter Counter) and preferably contain 18 to 22% by weight, in particular 20 to 22% by weight, of bound water.

It will be appreciated that it is also possible to use the commonly known phosphates as builder substances. Especially in the case of detergent tablets for machine dishwashing, these builders are of outstanding significance. Especially suitable are the sodium salts of the orthophosphates, of the pyrophosphates and especially of the tripolyphosphates.

Cleaning composition tablets for machine dishwashing are typically phosphate-based and contain preferably from 30 to 70% by weight, more preferably from 35 to 65% by weight and in particular from 45 to 60% by weight of phosphate(s), based in each case on the overall composition. Among the multitude of commercially available phosphates, the alkali metal phosphates, with particular preference for pentasodium triphosphate and pentapotassium triphosphate (sodium tripolyphosphate and potassium tripolyphosphate), have gained the greatest significance in the laundry detergents and cleaning compositions industry.

Alkali metal phosphates is the collective term for the alkali metal (especially sodium and potassium) salts of the different phosphoric acids, for which a distinction can be drawn of metaphosphoric acids (HPO₃)ₙ and orthophosphoric acid H₃PO₄ from higher molecular weight representatives. The phosphates combine several advantages: they function as alkali carriers, prevent limescale deposits on machine parts and limescale incrustations on fabrics and additionally contribute to the cleaning performance. Particularly suitable are, for example, sodium dihydrogenphosphate, NaH₂PO₄, disodium hydrogendiphosphate, Na₂H₂P₂O₇, trisodium phosphate, tetrasodium diphosphate (sodium pyrophosphate), Na₄P₂O₇, tertiary sodium phosphate Na₃PO₄, sodium trimetaphosphate (Na₃P₃O₉) and Maddrell's salt (see below), potassium dihydrogenphosphate (KH₂PO₄), dipotassium hydrogenphosphate (secondary or dibasic potassium phosphate), K₂HPO₄, tripotassium phosphate (tertiary or tribasic potassium phosphate), K₃PO₄, potassium polyphosphate (KPO₃)ₓ, potassium diphosphate (potassium pyrophosphate), K₄P₂O₇.

Condensation of NaH₂PO₄ or of KH₂PO₄ gives rise to higher molecular weight sodium phosphates and potassium phosphates, for which a distinction can be drawn between cyclic representatives, the sodium metaphosphates and potassium metaphosphates, and catenated types, the sodium polyphosphates and potassium polyphosphates. For the latter in particular a multitude of names are in use: fused or calcined phosphates, Graham's salt, Kurrol's salt and Maddrell's salt. All higher sodium and potassium phosphates are referred to collectively as condensed phosphates.

The industrially important pentasodium triphosphate, Na₅P₃O₁₀ (sodium tripolyphosphate), is a nonhygroscopic, white, water-soluble salt which is anhydrous or crystallizes with 6H₂O and has the general formula NaO—[P(O)(ONa)—O]ₙ—Na where n=3. About 17 g of the salt which is free of water of crystallization dissolve in 100 g of water at room temperature, at 600 approx. 20 g, at 1000 around 32 g; after the solution has been heated at 1000 for two hours, hydrolysis forms about 8% orthophosphate and 15% diphosphate. In the preparation of pentasodium triphosphate, phosphoric acid is reacted with sodium carbonate solution or sodium hydroxide solution in the stoichiometric ratio and the solution is dewatered by spraying. In a similar way to Graham's salt and sodium diphosphate, pentasodium triphosphate dissolves many insoluble metal compounds (including lime soaps etc.). Pentapotassium triphosphate, K₅P₃O₁₀ (potassium tripolyphosphate), is available commercially, for example, in the form of a 50% by weight solution (>23% P₂O₅, 25% K₂O). The potassium polyphosphates find wide use in the laundry detergents and cleaning products industry. There also exist sodium potassium tripolyphosphates which can likewise be used in the context of the present invention. They are formed, for example, when sodium trimetaphosphate is hydrolyzed with KOH:
(NaPO₃)₃+2KOH→Na₃K₂P₃O₁₀+H₂O
They can be used in accordance with the invention in precisely the same way as sodium tripolyphosphate, potassium tripolyphosphate or mixtures of the two; mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate can also be used in accordance with the invention.

Organic builder substances which can be used are, for example, the polycarboxylic acids usable in the form of their alkali metal and especially sodium salts, such as citric acid, adipic acid, succinic acid, glutaric acid, tartaric acid, sugar acids, aminocarboxylic acids, nitrilotriacetic acid (NTA), as long as such a use is not objectionable on ecological grounds, and mixtures thereof. Preferred salts are the salts of the polycarboxylic acids such as citric acid, adipic acid, succinic acid, glutaric acid, tartaric acid, sugar acids and mixtures thereof.

Alkali carriers may be present as further constituents. Alkali carriers include alkali metal hydroxides, alkali metal carbonates, alkali metal hydrogencarbonates, alkali metal sesquicarbonates, alkali metal silicates, alkali metal metasilicates and mixtures of the aforementioned substances, and preference is given in the context of this invention to using the alkali metal carbonates, especially sodium carbonate, sodium hydrogencarbonate or sodium sesquicarbonate.

When the inventive compositions are used for machine dishwashing, preference is given to water-soluble builders, since they generally have a lesser tendency to form insoluble residues on dishware and hard surfaces. Typical builders are the low molecular weight polycarboxylic acids and salts thereof, the homopolymeric and copolymeric polycarboxylic acids and salts thereof, the carbonates, phosphates and silicates. For the production of tablets for machine dishwashing, preference is given to using trisodium citrate and/or pentasodium tripolyphosphate and/or sodium carbonate and/or sodium bicarbonate and/or gluconates and/or silicatic builders from the class of the disilicates and/or metasilicates. Particular preference is given to a builder system comprising a mixture of tripolyphosphate and sodium carbonate. Particular preference is likewise given to a builder system which comprises a mixture of tripolyphosphate and sodium carbonate and sodium disilicate.

Organic cobuilders which may find use in the cleaning compositions in the context of the present invention are in particular polycarboxylates/polycarboxylic acids, polymeric polycarboxylates, aspartic acid, polyacetals, dextrins, further organic cobuilders (see below) and phosphonates. These substance classes are described below.

Organic builder substances which can be used are, for example, the polycarboxylic acids usable in the form of their sodium salts, polycarboxylic acids referring to carboxylic acids which bear more than one acid function. Examples of these are citric acid, adipic acid, succinic acid, glutaric acid, malic acid, tartaric acid, maleic acid, fumaric acid, sugar acids, aminocarboxylic acids, nitrilotriacetic acid (NTA), as long as such a use is not objectionable on ecological grounds, and mixtures thereof. Preferred salts are the salts of the polycarboxylic acids such as citric acid, adipic acid, succinic acid, glutaric acid, tartaric acid, methylglycinediacetic acid; sugar acids and mixtures thereof.

The acids themselves may also be used. In addition to their builder action, the acids typically also have the property of an acidifying component and thus also serve to establish a lower and milder pH of laundry detergents or cleaning compositions. In this connection, particular mention should be made of citric acid, succinic acid, glutaric acid, adipic acid, gluconic acid and any mixtures thereof.

Also suitable as builders are polymeric polycarboxylates; these are, for example, the alkali metal salts of polyacrylic acid or of polymethacrylic acid, for example those having a relative molecular mass of from 500 to 70 000 g/mol.

In the context of this document, the molar masses specified for polymeric polycarboxylates are weight-average molar masses Mw of the particular acid form, always having been determined by means of gel-permeation chromatography (GPC) using a UV detector. The measurement was made against an external polyacrylic acid standard which, owing to its structural similarity to the polymers under investigation, affords realistic molar weight values. These figures deviate considerably from the molar weight data obtained when polystyrenesulfonic acids are used as the standard. The molar masses measured against polystyrenesulfonic acids are generally distinctly higher than the molar masses specified in this document.

Suitable polymers are in particular polyacrylates which preferably have a molecular mass of from 1000 to 20 000 g/mol. Owing to their superior solubility, preference within this group may be given in turn to the short-chain polyacrylates which have molar masses of from 1000 to 10 000 g/mol and more preferably from 1200 to 4000 g/mol.

In the inventive compositions, particular preference is given to using both polyacrylates and copolymers of unsaturated carboxylic acids, monomers containing sulfonic acid groups, and optionally further ionic or nonionogenic monomers. The copolymers containing sulfonic acid groups are described in detail below.

However, it is also possible to provide inventive compositions which, as what are known as “3-in-1” products, combine the conventional detergents, rinse aids and a salt replacement function. For this purpose, preference is given to inventive machine dishwasher detergents which additionally contain from 0.1 to 70% by weight of copolymers of

i) unsaturated carboxylic acids

ii) sulfonic acid group-containing monomers

iii) optionally further ionic or nonionogenic monomers.

Additional positive effects of these copolymers are that the dishes treated with such compositions can be rinsed with higher water hardnesses, i.e. that no regenerating salt need be used up to a certain tap water hardness, and become distinctly cleaner in the course of subsequent cleaning operations than dishes which have been washed with conventional compositions.

In the context of the present invention, preferred monomers are unsaturated carboxylic acids of the formula I as a monomer
R¹(R²)C═C(R³)COOH (I)
in which R¹ to R³ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated straight-chain or branched hydrocarbon radical having from 1 to 12 carbon atoms.

Among the unsaturated carboxylic acids which can be described by the formula I, preference is given in particular to acrylic acid (R¹=R²=R³=H), methacrylic acid (R¹=R²=H; R³=CH₃) and/or maleic acid (R¹=COOH; R²=R³=H).

The monomers containing sulfonic acid groups are preferably those of the formula II
R⁵(R⁶)C═C(R⁷)—X—SO₃H (II)
in which R⁵ to R⁷ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms, and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—.

Among these monomers, preference is given to those of the formulae IIa, IIb and/or IIc
H₂C═CH—X—SO₃H (IIa)
H₂C═C(CH₃)—X—SO₃H (IIb)
HO₃S—X—(R⁶)C═C(R⁷)—X—SO₃H (IIc)
in which R⁶ and R⁷ are each independently selected from —H, —CH₃, —CH₂CH₃, —CH₂CH₂CH₃, —CH(CH₃)₂ and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—.

Particularly preferred monomers containing sulfonic acid groups are 1-acrylamido-1-propanesulfonic acid (X=—C(O)NH—CH(CH₂CH₃) in formula IIa), 2-acrylamido-2-propanesulfonic acid (X=—C(O)NH—C(CH₃)₂ in formula IIa), 2-acrylamido-2-methyl-1-propanesulfonic acid (X=—C(O)NH—CH(CH₃)CH₂— in formula IIa), 2-methacrylamido-2-methyl-1-propanesulfonic acid (X=—C(O)NH—CH(CH₃)CH₂— in formula IIb), 3-methacrylamido-2-hydroxypropanesulfonic acid (X=—C(O)NH—CH₂CH(OH)CH₂— in formula IIb), allylsulfonic acid (X=CH₂ in formula IIa), methallylsulfonic acid (X=CH₂ in formula IIb), allyloxybenzenesulfonic acid (X=—CH₂—O—C₆H₄— in formula IIa), methallyloxybenzenesulfonic acid (X=—CH₂—O—C₆H₄— in formula IIb), 2-hydroxy-3-(2-propenyloxy)propanesulfonic acid, 2-methyl-2-propene-1-sulfonic acid (X=CH₂ in formula IIb), styrenesulfonic acid (X=C₆H₄ in formula IIa), vinylsulfonic acid (X not present in formula IIa), 3-acrylamidopropanesulfonic acid (X=—C(O)NH—CH₂CH₂CH₂— in formula IIa), 3-methacrylamidopropanesulfonic acid (X=—C(O)NH—CH₂CH₂CH₂— in formula IIb), sulfomethacrylamide (X=—C(O)NH— in formula IIb), sulfomethylmethacrylamide (X=—C(O)NH—CH₂— in formula IIb) and water-soluble salts of the acids mentioned.

Useful further ionic or nonionogenic monomers are in particular ethylenically unsaturated compounds. The content of monomers of group iii) in the polymers used in accordance with the invention is preferably less than 20% by weight, based on the polymer. Polymers to be used more preferably consist only of monomers of groups i) and ii).

In summary, particular preference is given to copolymers of

i) unsaturated carboxylic acids of the formula I
R¹(R²)C═C(R³)COOH (I)
in which R¹ to R³ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms,
ii) monomers of the formula II containing sulfonic acid groups
R⁵(R⁶)C═C(R⁷)—X—SO₃H (II)
in which R⁵ to R⁷ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms, and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—
ii) optionally further ionic or nonionogenic monomers.

Particularly preferred copolymers consist of

i) one or more unsaturated carboxylic acids from the group of acrylic acid, methacrylic acid and/or maleic acid,

ii) one or more monomers containing sulfonic acid groups of the formulae IIa, IIb and/or IIc:
H₂C═CH—X—SO₃H (IIa)
H₂C═C(CH₃)—X—SO₃H (IIb)
HO₃S—X—(R⁶)C═C(R⁷)—X—SO₃H (IIc)
in which R⁶ and R⁷ are each independently selected from —H, —CH₃, —CH₂CH₃, —CH₂CH₂CH₃, —CH(CH₃)₂ and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—
   iii) optionally further ionic or nonionogenic monomers.

The copolymers present in the compositions may contain the monomers from groups i) and ii) and optionally iii) in varying amounts, and it is possible to combine any of the representatives from group i) with any of the representatives from group ii) and any of the representatives from group iii). Particularly preferred polymers have certain structural units which are described below.

For example, preference is given to inventive compositions which are characterized in that they comprise one or more copolymers which contain structural units of the formula III
—[CH₂—CHCOOH]ₘ—[CH₂—CHC(O)—Y—SO₃H]ₚ— (III)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

These polymers are prepared by copolymerization of acrylic acid with an acrylic acid derivative containing sulfonic acid groups. Copolymerizing the acrylic acid derivative containing sulfonic acid groups with methacrylic acid leads to another polymer, the use of which in the inventive compositions is likewise preferred and which is characterized in that the compositions comprise one or more copolymers which contain structural units of the formula IV
—[CH₂—C(CH₃)COOH]ₘ—[CH₂—CHC(O)—Y—SO₃H]ₚ— (IV)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

Acrylic acid and/or methacrylic acid can also be copolymerized entirely analogously with methacrylic acid derivatives containing sulfonic acid groups, which changes the structural units within the molecule. Thus, inventive compositions which comprise one or more copolymers which contain structural units of the formula V
—[CH₂—CHCOOH]ₘ—[CH₂—C(CH₃)C(O)—Y—SO₃H]ₚ— (V)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—, are likewise a preferred embodiment of the present invention, just like compositions which are characterized in that they comprise one or more copolymers which contain structural units of the formula VI
—[CH₂—C(CH₃)COOH]ₘ—[CH₂—C(CH₃)C(O)—Y—SO₃H]ₚ— (VI)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

Instead of acrylic acid and/or methacrylic acid, or in addition thereto, it is also possible to use maleic acid as a particularly preferred monomer from group i). This leads to compositions preferred in accordance with the invention which are characterized in that they comprise one or more copolymers which contain structural units of the formula VII
—[HOOCCH—CHCOOH]ₘ—[CH₂—CHC(O)—Y—SO₃H]ₚ— (VII)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—, and to compositions which are characterized in that they comprise one or more copolymers which contain structural units of the formula VIII
—[HOOCCH—CHCOOH]ₘ—[CH₂—C(CH₃)C(O)O—Y—SO₃H]ₚ— (VIII)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

In summary, preference is given to inventive machine dishwasher detergents which comprise, as ingredient b), one or more copolymers which contain structural units of the formulae III and/or IV and/or V and/or VI and/or VII and/or VIII
—[CH₂—CHCOOH]ₘ—[CH₂—CHC(O)—Y—SO₃H]ₚ— (III)
—[CH₂—C(CH₃)COOH]ₘ—[CH₂—CHC(O)—Y—SO₃H]ₚ— (IV)
—[CH₂—CHCOOH]ₘ—[CH₂—C(CH₃)C(O)—Y—SO₃H]ₚ— (V)
—[CH₂—C(CH₃)COOH]ₘ—[CH₂—C(CH₃)C(O)—Y—SO₃H]ₚ— (VI)
—[HOOCCH—CHCOOH]ₘ—[CH₂—CHC(O)—Y—SO₃H]ₚ— (VII)
—[HOOCCH—CHCOOH]ₘ—[CH₂—C(CH₃)C(O)O—Y—SO₃H]ₚ— (VII)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=0 to 4, is —O—(C₆H₄)—, is —NH—C(CH₃)₂— or —NH—CH(CH₂CH₃)—.

In the polymers, some or all of the sulfonic acid groups may be in neutralized form, i.e. the acidic hydrogen atom of the sulfonic acid group may be replaced in some or all of the sulfonic acid groups by metal ions, preferably alkali metal ions and in particular by sodium ions. Corresponding compositions which are characterized in that the sulfonic acid groups within the copolymer are present in partially or completely neutralized form are preferred in accordance with the invention.

The monomer distribution of the copolymers used in the inventive compositions is, in the case of copolymers which contain only monomers from groups i) and ii), preferably in each case from 5 to 95% by weight of i) or ii), more preferably from 50 to 90% by weight of monomer from group i) and from 10 to 50% by weight of monomer from group ii), based in each case on the polymer.

In the case of terpolymers, particular preference is given to those which contain from 20 to 85% by weight of monomer from group i), from 10 to 60% by weight of monomer from group ii), and from 5 to 30% by weight of monomer from group iii).

The molar mass of the polymers used in the inventive compositions can be varied in order to adapt the properties of the polymers to the desired intended use. Preferred machine dishwasher detergents are characterized in that the copolymers have molar masses of from 2000 to 200 000 gmol⁻¹, preferably from 4000 to 25 000 gmol⁻¹ and in particular from 5000 to 15 000 gmol⁻¹.

The content of one or more copolymers in the inventive compositions can vary depending on the intended use and desired product performance, and preferred inventive machine dishwashing detergents are characterized in that they contain the copolymer(s) in amounts of from 0.25 to 50% by weight, preferably from 0.5 to 35% by weight, more preferably from 0.75 to 20% by weight and in particular from 1 to 15% by weight.

As already mentioned above, particular preference is given to using in the inventive compositions both polyacrylates and the above-described copolymers of unsaturated carboxylic acids, monomers containing sulfonic acid groups and optionally further ionic or nonionogenic monomers. The polyacrylates have already been described in detail above. Particular preference is given to combinations of the above-described copolymers containing sulfonic acid groups with polyacrylates of low molar mass, for example in the range between 1000 and 4000 daltons. Such polyacrylates are commercially available under the trade names Sokalan® PA15 and Sokalan® PA25 (BASF).

Also suitable are copolymeric polycarboxylates, especially those of acrylic acid with methacrylic acid and of acrylic acid or methacrylic acid with maleic acid. Particularly suitable copolymers have been found to be those of acrylic acid with maleic acid which contain from 50 to 90% by weight of acrylic acid and from 50 to 10% by weight of maleic acid. Their relative molecular mass, based on free acids, is generally from 2000 to 100 000 g/mol, preferably from 20 000 to 90 000 g/mol and in particular from 30 000 to 80 000 g/mol.

The (co)polymeric polycarboxylates may be used either in the form of powder or in the form of an aqueous solution. The content in the compositions of (co)polymeric polycarboxylates is preferably from 0.5 to 20% by weight, in particular from 3 to 10% by weight.

To improve the water solubility, the polymers may also contain allylsulfonic acids, for example allyloxybenzenesulfonic acid and methallylsulfonic acid, as monomers.

Special preference is also given to biodegradable polymers composed of more than two different monomer units, for example those which contain, as monomers, salts of acrylic acid and of maleic acid and vinyl alcohol or vinyl alcohol derivatives, or which contain, as monomers, salts of acrylic acid and of 2-alkylallylsulfonic acid and sugar derivatives.

Useful cationic surfactants for the inventive compositions include all customary substances, and there is a distinct preference for cationic surfactants having textile-softening action.

The inventive compositions may comprise, as cationic active substances having textile-softening action, one or more cationic textile-softening agents of the formulae X, XI or XII: 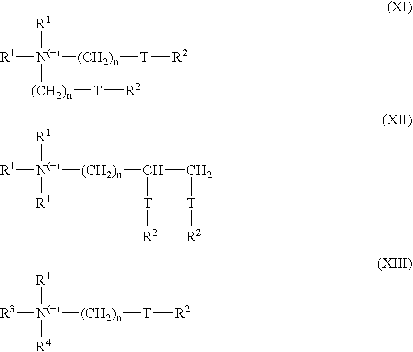
where each R¹ group is independently selected from C₁₋₆-alkyl, -alkenyl or -hydroxyalkyl groups; each R² group is independently selected from C₈₋₂₈-alkyl or -alkenyl groups; R³=R¹ or (CH₂)ₙ-T-R²; R⁴=R¹ or R² or (CH₂)ₙ-T-R²; T=—CH₂—, —O—CO— or —CO—O— and n is an integer from 0 to 5.

In preferred embodiments of the present invention, the laundry detergent or cleaning composition tablets additionally comprise nonionic surfactant(s) as the active substance.

The nonionic surfactants used are preferably alkoxylated, advantageously ethoxylated, in particular primary alcohols having preferably from 8 to 18 carbon atoms and on average from 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred alcohol ethoxylates have linear radicals of alcohols of native origin having from 12 to 18 carbon atoms, for example of coconut, palm, tallow fat or oleyl alcohol, and on average from 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO and mixtures thereof, such as mixtures of C₁₂₋₁₄-alcohol having 3 EO and C₁₂₋₁₈-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO.

Particularly preferred nonionic surfactants in the context of the present invention have been found to be low-foaming nonionic surfactants which have alternating ethylene oxide and alkylene oxide units. Among these, preference is given in turn to surfactants having EO-AO-EO-AO blocks, and in each case from 1 to 10 EO and/or AO groups are bonded to one another before a block of the other groups in each case follows. Preference is given here to inventive compositions which comprise, as nonionic surfactant(s), surfactants of the general formula XIV 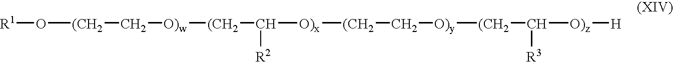
in which R¹ is a straight-chain or branched, saturated or mono- or polyunsaturated C₆₋₂₄-alkyl or -alkenyl radical; each R² or R³ group is independently selected from —CH₃; —CH₂CH₃, —CH₂CH₂—CH₃, —CH(CH₃)₂ and the indices w, x, y, z are each independently integers from 1 to 6.

The preferred nonionic surfactants of the formula XIV can be prepared by known methods from the corresponding alcohols R¹—OH and ethylene oxide or alkylene oxide. The R¹ radical in the above formula XIV may vary depending on the origin of the alcohol. When native sources are utilized, the R¹ radical has an even number of carbon atoms and is generally unbranched, and preference is given to the linear radicals of alcohols of native origin having from 12 to 18 carbon atoms, for example from coconut, palm, tallow fat or oleyl alcohol. Alcohols obtainable from synthetic sources are, for example, the Guerbet alcohols or 2-methyl-branched or linear and methyl-branched radicals in a mixture, as are typically present in oxo alcohol radicals. Irrespective of the type of the alcohol used to prepare the nonionic surfactants present in accordance with the invention in the compositions, preference is given to inventive compositions in which R¹ in formula XIV is an alkyl radical having from 6 to 24, preferably from 8 to 20, more preferably 9 to 15 and in particular 9 to 11 carbon atoms.

The alkylene oxide unit which is present in the preferred nonionic surfactants in alternation to the ethylene oxide unit is, as well as propylene oxide, especially butylene oxide. However, further alkylene oxides in which R² and R³ are each independently selected from —CH₂CH₂—CH₃ and —CH(CH₃)₂ are also suitable. Preferred compositions are characterized in that R² and R³ are each a —CH₃ radical, w and x are each independently 3 or 4, and y and z are each independently 1 or 2.

In summary, preference is given for use in the inventive compositions especially to nonionic surfactants which have a C₉₋₁₅ alkyl radical having from 1 to 4 ethylene oxide units, followed by from 1 to 4 propylene oxide units, followed by from 1 to 4 ethylene oxide units, followed by from 1 to 4 propylene oxide units.

The specified carbon chain lengths and degrees of ethoxylation or degrees of alkoxylation constitute statistical averages which may be a whole number or a fraction for a specific product. As a consequence of the preparation process, commercial products of the formulae specified do not usually consist of one individual representative, but rather of mixtures, as a result of which average values and consequently fractions can arise both for the carbon chain lengths and for the degrees of ethoxylation or degrees of alkoxylation.

In addition, further nonionic surfactants which may be used are also alkyl glycosides of the general formula RO(G)X in which R is a primary straight-chain or methyl-branched, in particular 2-methyl-branched, aliphatic radical having from 8 to 22, preferably from 12 to 18, carbon atoms and G is the symbol which represents a glycose unit having 5 or 6 carbon atoms, preferably glucose. The degree of oligomerization x, which specifies the distribution of monoglycosides and oligoglycosides, is any number between 1 and 10; x is preferably from 1.2 to 1.4.

A further class of nonionic surfactants used with preference, which are used either as the sole nonionic surfactant or in combination with other nonionic surfactants, are alkoxylated, preferably ethoxylated or ethoxylated and propoxylated, fatty acid alkyl esters, preferably having from 1 to 4 carbon atoms in the alkyl chain, in particular fatty acid methyl esters.

Nonionic surfactants of the amine oxide type, for example N-cocoalkyl-N,N-dimethylamine oxide and N-(tallow alkyl)-N,N-dihydroxyethylamine oxide, and of the fatty acid alkanolamide type may also be suitable. The amount of these nonionic surfactants is preferably not more than that of the ethoxylated fatty alcohols, in particular not more than half thereof.

Further suitable surfactants are polyhydroxy fatty acid amides of the formula (XV) 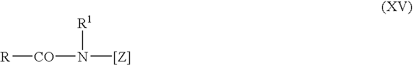
in which RCO is an aliphatic acyl radical having from 6 to 22 carbon atoms, R¹ is hydrogen, an alkyl or hydroxyalkyl radical having from 1 to 4 carbon atoms and [Z] is a linear or branched polyhydroxyalkyl radical having from 3 to 10 carbon atoms and from 3 to 10 hydroxyl groups. The polyhydroxy fatty acid amides are known substances which can typically be obtained by reductively aminating a reducing sugar with ammonia, an alkylamine or an alkanolamine, and subsequently acylating with a fatty acid, a fatty acid alkyl ester or a fatty acid chloride.

The group of polyhydroxy fatty acid amides also includes compounds of the formula (XVI) 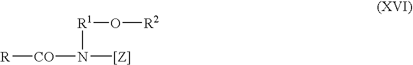
in which R is a linear or branched alkyl or alkenyl radical having from 7 to 12 carbon atoms, R¹ is a linear, branched or cyclic alkyl radical or an aryl radical having from 2 to 8 carbon atoms and R² is a linear, branched or cyclic alkyl radical or an aryl radical or an oxyalkyl radical having from 1 to 8 carbon atoms, preference being given to C₁₋₄-alkyl or phenyl radicals, and [Z] is a linear polyhydroxyalkyl radical whose alkyl chain is substituted by at least two hydroxyl groups, or alkoxylated, preferably ethoxylated or propoxylated, derivatives of this radical.

[Z] is preferably obtained by reductive amination of a reduced sugar, for example glucose, fructose, maltose, lactose, galactose, mannose or xylose. The N-alkoxy- or N-aryloxy-substituted compounds can be converted to the desired polyhydroxy fatty acid amides by reaction with fatty acid methyl esters in the presence of an alkoxide as catalyst.

It is particularly preferred for many applications when the ratio of anionic surfactant(s) to nonionic surfactant(s) is between 10:1 and 1:10, preferably between 7.5:1 and 1:5 and in particular between 5:1 and 1:2. Preference is given to inventive containers which contain surfactant(s), preferably anionic and/or nonionic surfactant(s), in amounts of from 5 to 80% by weight, preferably of from 7.5 to 70% by weight, more preferably of from 10 to 60% by weight and in particular of from 12.5 to 50% by weight, based in each case on the weight of the enclosed solids.

As already mentioned, the use of surfactants in detergents for machine dishwashing is preferably restricted to the use of nonionic surfactants in small amounts. When the inventive containers are intended to enclose such compositions, these compositions therefore preferably comprise only certain nonionic surfactants, which are described below. The surfactants used in machine dishwasher detergents are typically only low-foaming nonionic surfactants. Representatives from the groups of the anionic, cationic or amphoteric surfactants are therefore of lesser importance. The nonionic surfactants used are preferably alkoxylated, advantageously ethoxylated, in particular primary alcohols having preferably from 8 to 18 carbon atoms and on average from 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred alcohol ethoxylates have linear radicals of alcohols of native origin having from 12 to 18 carbon atoms, for example of coconut, palm, tallow fat or oleyl alcohol, and on average from 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO and mixtures thereof, such as mixtures of C₁₂₋₁₄-alcohol having 3 EO and C₁₂₋₁₈-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO.

Especially in the case of inventive cleaning composition tablets for machine dishwashing, it is preferred that they comprise a nonionic surfactant which has a melting point above room temperature, preferably a nonionic surfactant having a melting point above 20° C. Nonionic surfactants to be used with preference have melting points above 25° C.; nonionic surfactants to be used with particular preference have melting points between 25 and 60° C., in particular between 26.6 and 43.3° C.

Suitable nonionic surfactants which have melting or softening points in the temperature range specified are, for example, low-foaming nonionic surfactants which may be solid or highly viscous at room temperature. When nonionic surfactants which have a high viscosity at room temperature are used, they preferably have a viscosity above 20 Pas, more preferably above 35 Pas and in particular above 40 Pas. Nonionic surfactants which have a waxlike consistency at room temperature are also preferred.

Nonionic surfactants which are solid at room temperature and are to be used with preference originating from the groups of alkoxylated nonionic surfactants, in particular the ethoxylated primary alcohols and mixtures of these surfactants with structurally complex surfactants, such as polyoxypropylene/polyoxyethylene/polyoxypropylene (PO/EO/PO) surfactants. Such (PO/EO/PO) nonionic surfactants are additionally notable for good foam control.

In a preferred embodiment of the present invention, the nonionic surfactant with a melting point above room temperature is an ethoxylated nonionic surfactant which has resulted from the reaction of a monohydroxyalkanol or alkylphenol having from 6 to 20 carbon atoms with preferably at least 12 mol, more preferably at least 15 mol, in particular at least 20 mol, of ethylene oxide per mole of alcohol or alkylphenol.

A nonionic surfactant which is solid at room temperature and is to be used with particular preference is obtained from a straight-chain fatty alcohol having from 16 to 20 carbon atoms (C₁₆₋₂₀ alcohol), preferably a C₁₋₈ alcohol, and at least 12 mol, preferably at least 15 mol and in particular at least 20 mol, of ethylene oxide. Of these, the “narrow range ethoxylates” (see above) are particularly preferred.

The nonionic surfactant which is solid at room temperature preferably additionally has propylene oxide units in the molecule. Such PO units make up preferably up to 25% by weight, more preferably up to 20% by weight and in particular up to 15% by weight, of the total molar mass of the nonionic surfactant. Particularly preferred nonionic surfactants are ethoxylated monohydroxyalkanols or alkylphenols which additionally have polyoxyethylene-polyoxypropylene block copolymer units. The alcohol or alkylphenol moiety of such nonionic surfactant molecules preferably makes up more than 30% by weight, more preferably more than 50% by weight and in particular more than 70% by weight, of the total molar mass of such nonionic surfactants.

Further nonionic surfactants which have melting points above room temperature and are to be used with particular preference contain from 40 to 70% of a polyoxypropylene/polyoxyethylene/polyoxypropylene block polymer blend which contains 75% by weight of an inverse block copolymer of polyoxyethylene and polyoxypropylene having 17 mol of ethylene oxide and 44 mol of propylene oxide, and 25% by weight of a block copolymer of polyoxyethylene and polyoxypropylene initiated with trimethylolpropane and containing 24 mol of ethylene oxide and 99 mol of propylene oxide per mole of trimethylolpropane.

Nonionic surfactants which can be used with particular preference are obtainable, for example, under the name Poly Tergent® SLF-18 from Olin Chemicals.

A further preferred surfactant can be described by the formula
R¹O[CH₂CH(CH₃)O]ₓ[CH₂CH₂O]_{y}[CH₂CH(OH)R²]
in which R¹ is a linear or branched aliphatic hydrocarbon radical having from 4 to 18 carbon atoms or mixtures thereof, R² is a linear or branched hydrocarbon radical having from 2 to 26 carbon atoms or mixtures thereof, and x is a value between 0.5 and 1.5, and y is a value of at least 15.

Further nonionic surfactants which can be used with preference are the end group-capped poly(oxyalkylated) nonionic surfactants of the formula
R¹O[CH₂CH(R³)O]ₓ[CH₂]ₖCH(OH)[CH₂]ⱼOR²
in which R¹ and R² are linear or branched, saturated or unsaturated, aliphatic or aromatic hydrocarbon radicals having from 1 to 30 carbon atoms, R³ is H or a methyl, ethyl, n-propyl, isopropyl, n-butyl, 2-butyl or 2-methyl-2-butyl radical, x is a value between 1 and 30, k and j are values between 1 and 12, preferably between 1 and 5. When the value x is ≧2, each R³ in the above formula may be different. R¹ and R² are preferably linear or branched, saturated or unsaturated, aliphatic or aromatic hydrocarbon radicals having from 6 to 22 carbon atoms, particular preference being given to radicals having from 8 to 18 carbon atoms. For the R³ radical, particular preference is given to H, —CH₃ or —CH₂CH₃. Particularly preferred values for x are in the range from 1 to 20, in particular from 6 to 15.

As described above, each R³ in the above formula may be different if x is ≧2. This allows the alkylene oxide unit in the square brackets to be varied. When x is, for example, 3, the R³ radical may be selected so as to form ethylene oxide (R³=H) or propylene oxide (R³=CH₃) units which can be joined together in any sequence, for example (EO)(PO)(EO), (EO)(EO)(PO), (EO)(EO)(EO), (PO)(EO)(PO), (PO)(PO)(EO) and (PO)(PO)(PO). The value 3 for x is selected here by way of example and it is entirely possible for it to be larger, the scope of variation increasing with increasing x values and embracing, for example, a large number of (EO) groups combined with a small number of (PO) groups, or vice versa.

Especially preferred end group-capped poly(oxyalkylated) alcohols of the above formula have values of k=1 and j=1, so that the above formula is simplified to
R¹O[CH₂CH(R³)O]ₓCH₂CH(OH)CH₂OR².
In the latter formula, R¹, R² and R³ are each as defined above and x is a number from 1 to 30, preferably from 1 to 20 and in particular from 6 to 18. Particular preference is given to surfactants in which the R¹ and R² radicals have from 9 to 14 carbon atoms, R³ is H and x assumes values of from 6 to 15.

Preferred inventive compositions which are used as machine dishwasher detergents further comprise, in addition to the surfactants mentioned, amphoteric or cationic polymers to improve the rinse result.

To increase the washing or cleaning performance, inventive compositions may contain enzymes, in which case it is possible in principle to use any enzymes established for these purposes in the prior art. These include in particular proteases, amylases, lipases, hemicellulases, cellulases or oxidoreductases, and preferably mixtures thereof. These enzymes are in principle of natural origin; starting from the natural molecules, improved variants for use in laundry detergents and cleaning compositions are available and are preferably used accordingly. Inventive compositions preferably contain enzymes in total amounts of from 1×10⁻⁶ to 5 percent by weight based on active protein. The protein concentration may be determined with the aid of known methods, for example the BCA method (bicinchonic acid; 2,2′-biquinolyl-4,4′-dicarboxylic acid) or the biuret method.

Among the proteases, preference is given to those of the subtilisin type. Examples thereof include the subtilisins BPN′ and Carlsberg, protease PB92, the subtilisins 147 and 309, Bacillus lentus alkaline protease, subtilisin DY and the enzymes thermitase and proteinase K which can be classified to the subtilases but no longer to the subtilisins in the narrower sense, and the proteases TW3 and TW7. The subtilisin Carlsberg is available in a developed form under the trade name Alcalase® from Novozymes A/S, Bagsværd, Denmark. The subtilisins 147 and 309 are sold under the trade names Esperase® and Savinase® respectively by Novozymes. The variants listed under the name BLAP® are derived from the protease of Bacillus lentus DSM 5483.

Further examples of useful proteases are the enzymes available under the trade names Durazym®, Relase®, Everlase®, Nafizym, Natalase®, Kannase® and Ovozymes® from Novozymes, those under the trade names Purafect®, Purafect® OxP and Properase® from Genencor, that under the trade name Protosol® from Advanced Biochemicals Ltd., Thane, India, that under the trade name Wuxi® from Wuxi® Snyder Bioproducts Ltd., China, those under the trade names Proleather® and Protease P® from Amano Pharmaceuticals Ltd., Nagoya, Japan and that under the name Proteinase K-16 from Kao Corp., Tokyo, Japan.

Examples of amylases which can be used in accordance with the invention are the a-amylases from Bacillus licheniformis, from B. amyloliquefaciens or from B. stearothermophilus and developments thereof which have been improved for use in laundry detergents and cleaning compositions. The B. licheniformis enzyme is available from Novozymes under the name Termamyl® and from Genencor under the name Purastar® ST. Development products of this a-amylase are obtainable from Novozymes under the trade names Duramyl® and Termamyl® ultra, from Genencor under the name Purastar® OxAm and from Daiwa Seiko Inc., Tokyo, Japan as Keistase®. The B. amyloliquefaciens a-amylase is sold by Novozymes under the name BAN®, and variants derived from the B. stearothermophilus a-amylase under the names BS® and Novamyl®, likewise from Novozymes.

Enzymes which should additionally be emphasized for this purpose are the a-amylase from Bacillus sp. A 7-7 (DSM 12368), and the cyclodextrin glucanotransferase (CGTase) from B. agaradherens (DSM 9948); it is equally possible to use fusion products of the molecules mentioned.

Also suitable are the developments of a-amylase from Aspergillus niger and A. oryzae, which are available under the trade name Fungamyl® from Novozymes. Another example of a commercial product is Amylase-LT®.

Inventive compositions may comprise lipases or cutinases, especially owing to their triglyceride-cleaving activities, but also in order to generate peracids in situ from suitable precursors. Examples thereof include the lipases which were originally obtainable from Humicola lanuginosa (Thermomyces lanuginosus) or have been developed, in particular those with the D96L amino acid substitution. They are sold, for example, under the trade names Lipolase®, Lipolase®Ultra, LipoPrime®, Lipozyme® and Lipex® by Novozymes. It is additionally possible, for example, to use the cutinases which have originally been isolated from Fusarium solani pisi and Humicola insolens. Lipases which are also useful can be obtained under the designations Lipase CE®, Lipase P®, Lipase B®, or Lipase CES®, Lipase AKG®, Bacillis sp. Lipase®, Lipase AP®, Lipase M-AP® and Lipase AML® from Amano. Examples of lipases and cutinases from Genencor which can be used are those whose starting enzymes have originally been isolated from Pseudomonas mendocina and Fusarium solanii. Other important commercial products include the M1 Lipase® and Lipomax® preparations originally sold by Gist-Brocades and the enzymes sold under the names Lipase MY-30®, Lipase OF® and Lipase PL® by Meito Sangyo KK, Japan, and also the product Lumafast® from Genencor.

Inventive compositions may, especially when they are intended for the treatment of textiles, comprise cellulases, depending on the purpose either as pure enzymes, as enzyme preparations or in the form of mixtures in which the individual components advantageously complement one another with respect to their different performance aspects. These performance aspects include in particular contributions to the primary washing performance, to the secondary washing performance of the composition (antiredeposition action or graying inhibition) and hand (fabric action), up to exerting a “stone-wash” effect.

A useful fungal, endoglucanase(EG)-rich cellulase preparation and developments thereof are supplied under the trade name Celluzyme® from Novozymes. The products Endolase® and Carezyme®, likewise available from Novozymes, are based on the H. insolens DSM 1800 50 kD EG and 43 kD EG respectively. Further commercial products of this company, which may be used, are Cellusoft® and Renozyme®. It is equally possible to use the Melanocarpus 20 kD EG cellulase, which is available under the trade names Ecostone® and Biotouch® from AB Enzymes, Finland. Further commercial products from AB Enzymes are Econase® and Ecopulp®. A further suitable cellulase from Bacillus sp. CBS 670.93 is available under the trade name Puradax® from Genencor. Other commercial products from Genencor are Genencor detergent cellulase L and IndiAge®Neutra.

Inventive compositions may comprise further enzymes which are combined under the term hemicellulases. These include, for example, mannanases, xanthane lyases, pectin lyases (=pectinases), pectin esterases, pectate lyases, xyloglucanases (=xylanases), pullulanases and β-glucanases. Suitable mannanases are available, for example, under the names Gamanase® and Pektinex AR® from Novozymes, under the name Rohapec® B1L from AB Enzymes and under the name Pyrolase® from Diversa Corp., San Diego, Calif., USA. The β-glucanase obtained from B. subtilis is available under the name Cereflo® from Novozymes.

To enhance the bleaching action, inventive laundry detergents or cleaning compositions may comprise oxidoreductases, for example oxidases, oxygenases, catalases, peroxidases, such as haloperoxidases, chloroperoxidases, bromoperoxidases, lignin peroxidases, glucose peroxidases or manganese peroxidases, dioxygenases or laccases (phenol oxidases, polyphenol oxidases). Suitable commercial products include Denilite® 1 and 2 from Novozymes. Advantageously, preferably organic, more preferably aromatic, compounds which interact with the enzymes are additionally added in order to enhance the activity of the oxidoreductases concerned (enhancers), or to ensure the electron flux in the event of large differences in the redox potentials of the oxidizing enzymes and the soilings (mediators).

The enzymes used in inventive compositions either stem originally from microorganisms, for example of the genera Bacillus, Streptomyces, Humicola, or Pseudomonas, and/or are produced in biotechnology processes known per se by suitable microorganisms, for instance by transgenic expression hosts of the genera Bacillus or filamentous fungi.

The enzymes in question are favorably purified by means of processes which are established per se, for example by means of precipitation, sedimentation, concentration, filtration of the liquid phases, microfiltration, ultrafiltration, the action of chemicals, deodorization or suitable combinations of these steps.

The enzymes may be added to inventive compositions in any form established in the prior art. These include, for example, the solid preparations obtained by granulation, extrusion or lyophilization, or, especially in the case of liquid or gel-form compositions, solutions of the enzymes, advantageously highly concentrated, low in water and/or admixed with stabilizers.

Alternatively, the enzymes may be encapsulated either for the solid or for the liquid administration form, for example by spray-drying or extrusion of the enzyme solution together with a preferably natural polymer, or in the form of capsules, for example those in which the enzymes are enclosed as in a solidified gel, or in those of the core-shell type, in which an enzyme-containing core is coated with a water-, air- and/or chemical-impermeable protective layer. It is possible in layers applied thereto to additionally apply further active ingredients, for example stabilizers, emulsifiers, pigments, bleaches or dyes. Such capsules are applied by methods known per se, for example by agitated or roll granulation or in fluidized bed processes. Advantageously, such granules, for example as a result of application of polymeric film formers, are low-dusting and storage-stable owing to the coating.

It is also possible to formulate two or more enzymes together, so that a single granule has a plurality of enzyme activities.

A protein and/or enzyme present in an inventive composition may be protected, particularly during storage, from damage, for example inactivation, denaturation or decay, for instance by physical influences, oxidation or proteolytic cleavage. When the proteins and/or enzymes are obtained microbially, particular preference is given to inhibiting proteolysis, especially when the compositions also comprise proteases. For this purpose, inventive compositions may comprise stabilizers; the provision of such compositions constitutes a preferred embodiment of the present invention.

One group of stabilizers is that of reversible protease inhibitors. Frequently, benzamidine hydrochloride, borax, boric acids, boronic acids or salts or esters thereof are used, and of these in particular derivatives having aromatic groups, for example ortho-, meta- or para-substituted phenylboronic acids, or the salts or esters thereof. Peptide aldehydes, i.e. oligopeptides with reduced C-terminus are also suitable. Peptidic protease inhibitors which should be mentioned include ovomucoid and leupeptin; an additional option is the formation of fusion proteins of proteases and peptide inhibitors.

Further enzyme stabilizers are amino alcohols such as mono-, di-, triethanol- and -propanolamine and mixtures thereof, aliphatic carboxylic acids up to C₁₂, such as succinic acid, other dicarboxylic acids or salts of the acids mentioned. End group-capped fatty acid amide alkoxylates can also be used as stabilizers.

Lower aliphatic alcohols, but in particular polyols, for example glycerol, ethylene glycol, propylene glycol or sorbitol, are further frequently used enzyme stabilizers. Diglycerol phosphate also protects against denaturation by physical influences. Calcium salts are likewise used, for example calcium acetate or calcium formate, as are magnesium salts.

Polyamide oligomers or polymeric compounds such as lignin, water-soluble vinyl copolymers or cellulose ethers, acrylic polymers and/or polyamides stabilize the enzyme preparation against influences including physical influences or pH fluctuations. Polyamine N-oxide-containing polymers act simultaneously as enzyme stabilizers and as dye transfer inhibitors. Other polymeric stabilizers are the linear C₈-C₁₈ polyoxyalkylenes. Alkylpolyglycosides can likewise stabilize the enzymatic components of the inventive composition and even increase their performance. Crosslinked N-containing compounds fulfill a double function as soil release agents and as enzyme stabilizers.

Reducing agents and antioxidants, such as sodium sulfite or reducing sugars, increase the stability of the enzymes against oxidative decay.

Preference is given to using combinations of stabilizers, for example of polyols, boric acid and/or borax, the combination of boric acid or borate, reducing salts and succinic acid or other dicarboxylic acids or the combination of boric acid or borate with polyols or polyamino compounds and with reducing salts. The action of peptide-aldehyde stabilizers can be increased by the combination with boric acid and/or boric acid derivatives and polyols, and further enhanced by the additional use of divalent cations, for example calcium ions.

Particular preference is given in the context of the present invention to the use of liquid enzyme formulations. Preference is given here to inventive compositions which additionally comprise enzymes and/or enzyme preparations, preferably solid and/or liquid protease preparations and/or amylase preparations, in amounts of from 1 to 5% by weight, preferably of from 1.5 to 4.5% by weight and in particular from 2 to 4% by weight, based in each case on the overall composition.

In order to ease the decomposition of the inventive tablets, these tablets may comprise disintegration assistants, known as tablet disintegrants. Tablet disintegrants or disintegration accelerators refer to assistants according to Römpp (9th edition, vol. 6, p. 4440) and Voigt “Lehrbuch der pharmazeutischen Technologie” [Textbook of pharmaceutical technology] (6th edition, 1987, p. 182-184) which ensure the rapid decomposition of tablets in water or gastric juice and the release of pharmaceuticals in absorbable form.

These substances which are also referred to as “breakup” agents owing to their action increase their volume on entry of water, and it is either the increase in the intrinsic volume (swelling) or the release of gases that can generate a pressure that causes the tablets to disintegrate into smaller particles. Disintegration assistants which have been known for some time are, for example, carbonate/citric acid systems, although other organic acids may also be used. Swelling disintegration assistants are, for example, synthetic polymers such as polyvinylpyrrolidone (PVP) or natural polymers or modified natural substances such as cellulose and starch and derivatives thereof, alginates or casein derivatives. All disintegration assistants mentioned can be used in accordance with the invention.

Preferred disintegration assistants used in the context of the present invention are disintegration assistants based on cellulose, preferably in granular, cogranulated or compacted form.

Pure cellulose has the formal empirical composition (C₆H₁₀O₅)ₙ and, viewed in a formal sense, is a β-1,4-polyacetal of cellobiose which is in turn formed from two molecules of glucose. Suitable celluloses consist of from approx. 500 to 5000 glucose units and accordingly have average molar masses of from 50 000 to 500 000. Useful disintegrants based on cellulose in the context of the present invention are also cellulose derivatives which are obtainable by polymer-like reactions from cellulose. Such chemically modified celluloses comprise, for example, products of esterifications and etherifications in which hydroxyl hydrogen atoms have been substituted. However, celluloses in which the hydroxyl groups have been replaced by functional groups which are not bonded by means of an oxygen atom can also be used as cellulose derivatives. The group of the cellulose derivatives includes, for example, alkali metal celluloses, carboxymethylcellulose (CMC), cellulose esters and ethers, and amino celluloses.

The cellulose derivatives mentioned are preferably not used alone as disintegrants based on cellulose, but rather in a mixture with cellulose. The content of cellulose derivatives in these mixtures is preferably below 50% by weight, more preferably below 20% by weight, based on the disintegrant based on cellulose. The disintegrant based on cellulose which is used is more preferably pure cellulose which is free of cellulose derivatives. As a further disintegrant based on cellulose or as a constituent of this component, microcrystalline cellulose can be used. This microcrystalline cellulose is obtained by partial hydrolysis of celluloses under such conditions that only the amorphous regions (approx. 30% of the total cellulose mass) of the celluloses are attacked and fully dissolved, but the crystalline regions (approx. 70%) are left undamaged. A subsequent deaggregation of the microfine celluloses formed by the hydrolysis affords the microcrystalline celluloses which have primary particle sizes of approx. 5 μm and can be compacted, for example, to give granules having an average particle size of 200 μm.

In addition to or instead of the disintegration assistants based on cellulose, the inventive products may comprise a gas-releasing system composed of organic acids and carbonates/hydrogencarbonates.

Useful organic acids which release carbon dioxide from the carbonates/hydrogencarbonates in aqueous solution are, for example, the solid mono-, oligo- and polycarboxylic acids. From this group, preference is given in turn to citric acid, tartaric acid, succinic acid, malonic acid, adipic acid, maleic acid, fumaric acid, oxalic acid and polyacrylic acid. Organic sulfonic acids such as amidosulfonic acid can likewise be used. Commercially available and likewise usable with preference as an acidifier in the context of the present invention is Sokalan® DCS (trademark of BASF), a mixture of succinic acid (max. 31% by weight), glutaric acid (max. 50% by weight) and adipic acid (max. 33% by weight).

The acids mentioned do not have to be used stoichiometrically to the carbonates and hydrogencarbonates present in the compacts.

A laundry detergent or cleaning composition compact which is preferred in the context of the present invention additionally comprises an effervescent system.

The gas-evolving effervescent system consists, in the inventive compositions, in addition to the organic acids mentioned, of carbonates and/or hydrogencarbonates. Among the representatives of this substance class, there is a distinct preference for the alkali metal salts for reasons of cost. Among the alkali metal carbonates and hydrogencarbonates, there is in turn a distinct preference for the sodium and potassium salts over the other salts for reasons of cost. It will be appreciated that the pure alkali metal carbonates or hydrogencarbonates in question do not have to be used; rather, mixtures of different carbonates and hydrogencarbonates may be preferred.

The electrolytes used from the group of the inorganic salts may be a wide range of highly varying salts. Preferred cations are the alkali metals and alkaline earth metals; preferred anions are the halides and sulfates. From a production point of view, preference is given to the use of NaCl or MgCl₂ in the inventive products.

In order to bring the pH into the desired range, it may be appropriate to use pH modifiers. It is possible here to use all known acids or alkalis, as long as their use is not forbidden on performance or ecological grounds or on grounds of consumer protection. Typically, the amount of these modifiers does not exceed 1% by weight of the overall formulation.

The perfume oils or fragrances used may in the context of the present invention be individual odorant compounds, for example the synthetic products of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate and benzyl salicylate. The ethers include, for example, benzyl ethyl ether, the aldehydes include, for example, the linear alkanals having from 8 to 18 carbon atoms, citral, citronellal, citronellyloxyacetaldehyde, cyclamen aldehyde, hydroxycitronellal, lilial and bourgeonal, the ketones include, for example, the ionones, α-isomethylionone and methyl cedryl ketone, the alcohols include anethol, citronellol, eugenol, geraniol, linalool, phenylethyl alcohol and terpineol, the hydrocarbons include primarily the terpenes, such as limonene and pinene. However, preference is given to using mixtures of different odorants which together generate a pleasing fragrance note. Such perfume oils may also contain natural odorant mixtures, as obtainable from vegetable sources, e.g. pine oil, citrus oil, jasmine oil, patchouli oil, rose oil and ylang-ylang oil. Likewise suitable are muscatel, sage oil, camomile oil, oil of cloves, melissa oil, mint oil, cinnamon leaf oil, lime blossom oil, juniperberry oil, vetiver oil, olibanum oil, galbanum oil and labdanum oil, and orange blossom oil, neroliol, orange peel oil and sandalwood oil.

The general description of the perfumes which can be used (see above) is a general representation of the different classes of odorant substances. In order to be perceptible, an odorant must be volatile, for which an important role is played not only by the nature of the functional groups and by the structure of the chemical compound but also by the molar mass. Thus, the majority of odorants have molar masses of up to about 200 daltons, while molar masses of 300 daltons or more tend to be an exception. On the basis of the different volatility of odorants there is a change in the odor of a perfume or fragrance composed of two or more odorants during its evaporation, and the perceived odors are divided into top note, middle note or body, and end note or dryout. Since the perception of odor is to a large extent also based on the odor intensity, the top note of a perfume or fragrance mixture does not consist only of volatile compounds, whereas the base note consists for the most part of less volatile odorants, i.e., odorants which adhere firmly. In the composition of perfumes it is possible for more volatile odorants, for example, to be bound to certain fixatives, which prevent them from evaporating too rapidly. The subsequent classification of the odorants into “more volatile” and “firmly adhering” odorants, therefore, states nothing about the perceived odor and about whether the odorant in question is perceived as a top note or as a middle note.

Examples of firmly adhering odorants which can be used in the context of the present invention are the essential oils such as angelica root oil, anise oil, arnica blossom oil, basil oil, bay oil, bergamot oil, champaca blossom oil, noble fir oil, noble fir cone oil, elemi oil, eucalyptus oil, fennel oil, spruce needle oil, galbanum oil, geranium oil, ginger grass oil, guaiacwood oil, gurjun balsam oil, helichrysum oil, ho oil, ginger oil, iris oil, cajeput oil, calamus oil, camomile oil, camphor oil, canaga oil, cardamom oil, cassia oil, pine needle oil, copaiva balsam oil, coriander oil, spearmint oil, caraway oil, cumin oil, lavender oil, lemon grass oil, lime oil, mandarin oil, balm oil, musk seed oil, myrrh oil, clove oil, neroli oil, niaouli oil, olibanum oil, orange oil, origanum oil, palmarosa oil, patchouli oil, Peru balsam oil, petitgrain oil, pepper oil, peppermint oil, pimento oil, pine oil, rose oil, rosemary oil, sandalwood oil, celery oil, spike oil, star anise oil, turpentine oil, thuja oil, thyme oil, verbena oil, vetiver oil, juniperberry oil, wormwood oil, wintergreen oil, ylang-ylang oil, hyssop oil, cinnamon oil, cinnamon leaf oil, citronellol, lemon oil and cypress oil. However, the higher-boiling or solid odorants of natural or synthetic origin may also be used in the context of the present invention as firmly adhering odorants or odorant mixtures, i.e. fragrances. These compounds include the following compounds and mixtures thereof: ambrettolide, α-amylcinnamaldehyde, anethole, anisaldehyde, anisyl alcohol, anisole, methyl anthranilate, acetophenone, benzylacetone, benzaldehyde, ethyl benzoate, benzophenone, benzyl alcohol, benzyl acetate, benzyl benzoate, benzyl formate, benzyl valerate, borneol, bornyl acetate, α-bromostyrene, n-decylaldehyde, n-dodecylaldehyde, eugenol, eugenol methyl ether, eucalyptol, farnesol, fenchone, fenchyl acetate, geranyl acetate, geranyl formate, heliotropin, methyl heptynecarboxylate, heptaldehyde, hydroquinone dimethyl ether, hydroxycinnamaldehyde, hydroxycinnamyl alcohol, indole, irone, isoeugenol, isoeugenol methyl ether, isosafrol, jasmone, camphor, carvacrol, carvone, p-cresol methyl ether, coumarin, p-methoxyacetophenone, methyl n-amyl ketone, methyl methylanthranilate, p-methylacetophenone, methylchavicol, p-methylquinoline, methyl β-naphthyl ketone, methyl-n-nonylacetaldehyde, methyl n-nonyl ketone, muscone, β-naphthol ethyl ether, β-naphthol methyl ether, nerol, nitrobenzene, n-nonylaldehyde, nonyl alcohol, n-octylaldehyde, p-oxyacetophenone, pentadecanolide, β-phenylethyl alcohol, phenylacetaldehyde dimethyl acetal, phenylacetic acid, pulegone, safrol, isoamyl salicylate, methyl salicylate, hexyl salicylate, cyclohexyl salicylate, santalol, skatole, terpineol, thymene, thymol, γ-undecalactone, vanillin, veratrum aldehyde, cinnamaldehyde, cinnamyl alcohol, cinnamic acid, ethyl cinnamate, benzyl cinnamate. The more volatile odorants include in particular the lower-boiling odorants of natural or synthetic origin, which may be used alone or in mixtures. Examples of more volatile odorants are alkyl isothiocyanates (alkyl mustard oils), butanedione, limonene, linalool, linalyl acetate and linalyl propionate, menthol, menthone, methyl-n-heptenone, phellandrene, phenylacetaldehyde, terpinyl acetate, citral, citronellal.

In order to improve the esthetic appearance of the inventive compositions, they may be colored with suitable dyes. Preferred dyes, whose selection presents no difficulty whatsoever to those skilled in the art, have a high storage stability and insensitivity toward the other ingredients of the compositions and toward light. When the inventive containers enclose laundry detergent and cleaning compositions for cleaning textiles, the dyes used should also have no marked substantivity toward textiles in order not to color them.

Hydrotropes or solubilizers refer to substances which, by their presence, make other compounds which are virtually insoluble in a certain solvent soluble or emulsifiable in this solvent (solubilization). There are solubilizers which enter into a molecular bond with the sparingly soluble substance and those which act by micelle formation. It can also be said that solubilizers actually impart dissolution power to a “latent” solvent. In the case of water as the (latent) solvent, reference is made usually to hydrotropes instead of solubilizers, and in certain cases it is better to refer to emulsifiers.

Useful foam inhibitors which may be used in the inventive compositions include soaps, oils, fats, paraffins or silicone oils, which may optionally be applied to support materials. Suitable support materials are, for example, inorganic salts such as carbonates or sulfates, cellulose derivatives or silicates and mixtures of the aforementioned materials. Compositions which are preferred in the context of the present application comprise paraffins, preferably unbranched paraffins (n-paraffins) and/or silicones, preferably linear polymeric silicones which have the composition according to the scheme (R₂SiO)ₓ and are also referred to as silicone oils. These silicone oils are commonly clear, colorless, neutral, odorless, hydrophobic liquids having a molecular weight between 1000-150 000, and viscosities between 10 and 1 000 000 mPa·s.

Suitable antiredeposition agents, which are also referred to as soil repellents, are, for example, nonionic cellulose ethers, such as methylcellulose and methylhydroxypropyl-cellulose having a proportion of methoxy groups of from 15 to 30% by weight and of hydroxypropyl groups of from 1 to 15% by weight, based in each case on the nonionic cellulose ethers, and the prior art polymers of phthalic acid and/or terephthalic acid or derivatives thereof, in particular polymers of ethylene terephthalates and/or polyethylene glycol terephthalates or anionically and/or nonionically modified derivatives thereof. Of these, particular preference is given to the sulfonated derivatives of phthalic acid polymers and terephthalic acid polymers.

Optical brighteners (known as “whiteners”) may be added to the inventive compositions in order to eliminate graying and yellowing of the treated textiles. These substances attach to the fibers and bring about brightening and simulated bleaching action by converting invisible ultraviolet radiation to visible longer-wavelength light, in the course of which the ultraviolet light absorbed from sunlight is radiated as pale bluish fluorescence and, together with the yellow shade of the grayed or yellowed laundry, results in pure white. Suitable compounds stem, for example, from the substance classes of 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazole, benzisoxazole and benzimidazole systems, and the pyrene derivatives substituted by heterocycles.

Graying inhibitors have the task of keeping the soil detached from the fiber suspended in the liquor, thus preventing the soil from reattaching. Suitable for this purpose are water-soluble colloids, usually of organic nature, for example the water-soluble salts of polymeric carboxylic acids, size, gelatin, salts of ether sulfonic acids of starch or of cellulose, or salts of acidic sulfuric esters of cellulose or of starch. Water-soluble polyamides containing acidic groups are also suitable for this purpose. In addition, it is possible to use soluble starch preparations, and starch products other than those mentioned above, for example degraded starch, aldehyde starches, etc. It is also possible to use polyvinylpyrrolidone. Also usable as graying inhibitors are cellulose ethers such as carboxymethylcellulose (sodium salt), methylcellulose, hydroxyalkylcellulose and mixed ethers such as methylhydroxyethylcellulose, methylhydroxypropylcellulose, methylcarboxymethylcellulose and mixtures thereof.

Since textile fabrics, in particular those made of rayon, viscose, cotton and mixtures thereof, can tend to crease because the individual fibers are sensitive toward bending, folding, compressing and crushing transverse to the fiber direction, the inventive compositions may comprise synthetic anticrease agents. These include, for example, synthetic products based on fatty acids, fatty acid esters, fatty acid amides, fatty acid alkylol esters, fatty acid alkylolamides or fatty alcohols, which have usually been reacted with ethylene oxide, or products based on lecithin or modified phosphoric esters. A substance suitable to a particular degree for textile finishing and care is cottonseed oil which can be produced, for example, by extractively pressing the brown cleaned cottonseeds and refining with about 10% sodium hydroxide or by extracting with hexane at 60-70° C. Such cotton oils contain from 40 to 55% by weight of linoleic acid, from 16 to 26% by weight of oleic acid and from 20 to 26% by weight of palmitic acid. Further particularly preferred products for fiber smoothing and fibercare are the glycerides, especially the monoglycerides of fatty acids, for example glycerol monooleate oder glycerol monostearate.

To control microorganisms, the inventive compositions may comprise active antimicrobial ingredients. A distinction is drawn here, depending on the antimicrobial spectrum and mechanism of action, between bacteriostats and bactericides, fungistats and fungicides, etc. Important substances from these groups are, for example, benzalkonium chlorides, alkylarylsulfonates, halophenols and phenylmercuric acetate, although it is also possible to dispense entirely with these compounds in the inventive compositions.

In order to prevent undesired changes, caused by the action of oxygen and other oxidative processes, to the laundry detergents and cleaning compositions and/or the textiles treated, the inventive compositions may comprise antioxidants. This class of compound includes, for example, substituted phenols, hydroquinones, pyrocatechols and aromatic amines, and also organic sulfides, polysulfides, dithiocarbamates, phosphites and phosphonates.

Increased wear comfort can result from the additional use of antistats which are additionally added to the inventive compositions. Antistats increase the surface conductivity and thus permit improved discharge of charges formed. External antistats are generally substances having at least one hydrophilic molecular ligand and impart to the surfaces a more or less hygroscopic film. These usually interface-active antistats can be subdivided into nitrogen antistats (amines, amides, quaternary ammonium compounds), phosphorus antistats (phosphoric esters) and sulfur antistats (alkylsulfonates, alkyl sulfates). Lauryl- (or stearyl)dimethylbenzylammonium chlorides are likewise suitable as antistats for textiles or as additives for detergents, in which case a softening effect is additionally achieved.

Repellency and impregnation processes serve to finish textiles with substances which prevent the deposition of soil or make it easier to wash out. Preferred repellents and impregnating agents are perfluorinated fatty acids, also in the form of their aluminum and zirconium salts, organic silicates, silicones, polyacrylic esters having a perfluorinated alcohol component or polymerizable compounds having a coupled, perfluorinated acyl or sulfonyl radical. Antistats may also be present. The soil-repellent finish with repellents and impregnating agents is often classified as an easycare finish. The penetration of the impregnating agents in the form of solutions or emulsions of the active ingredients in question may be eased by adding wetting agents which lower the surface tension. A further field of use of repellents and impregnating agents is the water-repellent finishing of textiles, tents, tarpaulins, leather, etc., in which, in contrast to waterproofing, the fabric pores are not sealed and the substance thus remains breathable (hydrophobizing). The hydrophobizing agents used for the hydrophobization coat textiles, leather, paper, wood, etc., with a very thin layer of hydrophobic groups such as relatively long alkyl chains or siloxane groups. Suitable hydrophobizing agents are, for example, paraffins, waxes, metal soaps, etc., with additives of aluminum or zirconium salts, quaternary ammonium compounds having long-chain alkyl radicals, urea derivatives, fatty acid-modified melamine resins, chromium complex salts, silicones, organotin compounds and glutaraldehyde, and also perfluorinated compounds. The hydrophobized materials do not have a greasy feel, but water drops, similarly to the way they do on greased substances, run off them without wetting them. For example, silicone-impregnated textiles have a soft hand and are water- and soil-repellant. Stains of ink, wine, fruit juices and the like can be removed more easily.

For the care of the textiles and for an improvement in the textile properties such as a softer “hand” (softening) and reduced electrostatic charge (increased wear comfort), the inventive compositions may comprise fabric softeners. The active ingredients in fabric softener formulations are ester quats, quaternary ammonium compounds having two hydrophobic radicals, for example distearyldimethylammonium chloride which, however, owing to its inadequate biodegradability, is increasingly being replaced by quaternary ammonium compounds which contain ester groups in their hydrophobic radicals as intended cleavage sites for biodegradation. Such ester quats having improved biodegradability are obtainable, for example, by esterifying mixtures of methyldiethanolamine and/or triethanolamine with fatty acids and subsequently quaternizing the reaction products with alkylating agents in a manner known per se. Another suitable finish is dimethylolethyleneurea.

To improve the water-absorption capacity and the rewettability of the treated textiles, and to ease the ironing of these textiles, it is possible to use silicone derivatives, for example, in the inventive compositions. They additionally improve the rinse-out performance of the inventive compositions by virtue of their foam-inhibiting properties. Preferred silicone derivatives are, for example, polydialkyl- or alkylarylsiloxanes in which the alkyl groups have from one to five carbon atoms and are fully or partly fluorinated. Preferred silicones are polydimethylsiloxanes which may optionally be derivatized and are in that case amino-functional or quaternized or have Si—OH, Si—H and/or Si—Cl bonds. Further preferred silicones are the polyalkylene oxide-modified polysiloxanes, i.e. polysiloxanes which have polyethylene glycols, for example, and the polyalkylene oxide-modified dimethyl polysiloxanes.

Owing to their fibercare action, protein hydrolyzates are further preferred active substances from the field of laundry detergents and cleaning compositions in the context of the present invention. Protein hydrolyzates are product mixtures which are obtained by acid-, base- or enzyme-catalyzed degradation of proteins. According to the invention, protein hydrolyzates either of vegetable or animal origin may be used. Animal protein hydrolyzates are, for example, elastin, collagen, keratin, silk and milk protein hydrolyzates which may also be present in the form of salts. Preference is given in accordance with the invention to the use of protein hydrolyzates of vegetable origin, for example soybean, almond, rice, pea, potato and wheat protein hydrolyzates. Although preference is given to the use of the protein hydrolyzates as such, it is in some cases also possible to use in their stead amino acid mixtures or individual amino acids obtained in other ways, for example arginine, lysine, histidine or pyroglutamic acid. It is likewise possible to use derivatives of protein hydrolyzates, for example in the form of their fatty acid condensates.

Finally, the inventive compositions may also comprise UV absorbers which attach to the treated textiles and improve the photoresistance of the fibers. Compounds which have these desired properties are, for example, the compounds and derivatives of benzophenone having substituents in the 2- and/or 4-position which are active by virtue of radiationless deactivation. Also suitable are substituted benzotriazoles, 3-phenyl-substituted acrylates (cinnamic acid derivatives), optionally having cyano groups in the 2-position, salicylates, organic nickel complexes and natural substances such as umbelliferone and endogenous urocanic acid.

To protect the ware or the machine, detergents for machine dishwashing may comprise corrosion inhibitors, and in particular silver protectants and glass corrosion inhibitors have special significance in the field of machine dishwashing. It is possible to use the known prior art substances. In general, it is possible in particular to use silver protectants selected from the group of the triazoles, the benzotriazoles, the bisbenzotriazoles, the aminotriazoles, the alkylaminotriazoles and the transition metal salts or complexes. Particular preference is given to using benzotriazole and/or alkylaminotriazole. Additionally found in cleaning formulations are frequently active chlorine-containing agents which can distinctly reduce the corrosion of the silver surface. In chlorine-free cleaners, particularly oxygen- and nitrogen-containing organic redox-active compounds are used, such as di- and trivalent phenols, e.g. hydroquinone, pyrocatechol, hydroxyhydroquinone, gallic acid, phloroglucine, pyrogallol or derivatives of these compound classes. Salt- and complex-type inorganic compounds such as salts of the metals Mn, Ti, Zr, Hf, V, Co and Ce frequently also find use. Preference is given here to the transition metal salts which are selected from the group of the manganese and/or cobalt salts and/or complexes, more preferably the cobalt (ammine) complexes, the cobalt (acetate) complexes, the cobalt (carbonyl) complexes, the chlorides of cobalt or manganese and of manganese sulfate, and the manganese complexes
[(Me-TACN)Mn^{IV}(m-0)₃Mn^{IV}(Me-TACN)]²⁺(PF₆⁻)₂,
[(Me-MeTACN)Mn^{IV}(m-0)₃Mn^{IV}(Me-MeTACN)]²⁺(PF₆—)₂,
[(Me-TACN)Mn^{III}(m-0)(m-0Ac)₂Mn^{III}(Me-TACN)]²⁺(PF₆⁻)₂ and
[(Me-MeTACN)Mn^{III}(m-0)(m-0Ac)₂Mn^{III}(Me-MeTACN)]²⁺(PF₆⁻)₂,
where Me-TACN is 1,7-trimethyl-1,4,7-triazacyclononane and Me-MeTACN is 1,2,4,7-tetramethyl-1,4,7-triazacyclononane. It is likewise possible to use zinc compounds to prevent corrosion of the ware.

In the context of the present invention, preference is given to additionally using at least one silver protectant selected from the group of the triazoles, the benzotriazoles, the bisbenzotriazoles, the aminotriazoles, the alkylaminotriazoles, preferably benzotriazole and/or alkylaminotriazole in amounts of from 0.001 to 1% by weight, preferably from 0.01 to 0.5% by weight and in particular from 0.05 to 0.25% by weight, based in each case on the total weight of the inventive cleaning composition tablets.

In addition to the aforementioned silver protectants, inventive compositions may further comprise one or more substances for reducing glass corrosion. In the context of the present application, preference is given especially to additives of zinc and/or inorganic and/or organic zinc salts and/or silicates, for example the sheet-type crystalline sodium disilicate SKS 6 from Clariant GmbH, and/or water-soluble glasses, for example glasses which have a mass loss of at least 0.5 mg under the conditions specified in DIN ISO 719 for the reduction of glass corrosion. Particularly preferred compositions comprise at least one zinc salt of an organic acid, preferably selected from the group of zinc oleate, zinc stearate, zinc gluconate, zinc acetate, zinc lactate and zinc citrate.

1. A laundry detergent or cleaning composition tablet, characterized in that the tablet has a bottom face and a top face, the two faces not being plane-parallel over at least half of the size of the smaller face.

2. The laundry detergent or cleaning composition tablet as claimed in claim 1, characterized in that the bottom face and top face are not plane-parallel over the entire size of the smaller face.

3. The laundry detergent or cleaning composition tablet as claimed in claim 1, characterized in that the bottom face is planar to an extent of at least 50% over the whole face.

4. The laundry detergent or cleaning composition tablet as claimed in claim 1, characterized in that the top face is planar to an extent of at least 35%.

5. The laundry detergent or cleaning composition tablet as claimed in claim 1, characterized in that the non-plane-parallel proportions of the bottom face and top face form with one another an angle of from 10 to 300.

6. The laundry detergent or cleaning composition tablet as claimed in claim 1, characterized in that at least one lateral limiting face which connects bottom face and top face is nonvertical over at least 60% of its height.

7. The laundry detergent or cleaning composition tablet as claimed in claim 1, characterized in that it has four lateral limiting faces of which one is nonvertical over at least half of its height.

8. The laundry detergent or cleaning composition tablet as claimed in claim 1, characterized in that it has a multiphase structure.

9. The laundry detergent or cleaning composition tablet as characterized in claim 1, wherein the faces have beveled edges.

10. The laundry detergent or cleaning composition tablet as characterized in claim 1, wherein the tablet has a density about 1100 kgm⁻³.

11. The laundry detergent or cleaning composition tablet as characterized in claim 1, wherein the tablet has a multilayer structure.

12. The laundry detergent or cleaning composition tablet as characterized in claim 11, wherein one of the layers is substantially dissolved in the pre-wash.

13. A laundry detergent or cleaning composition tablet characterized in that the tablet has a bottom face and a top face, the two faces not being plane parallel over at least half of the size of the smaller face and characterized in that the top face has at least one cavity into which a separately produced molding can be introduced.

14. The laundry detergent or cleaning composition tablet as characterized in claim 13, in which the separately produced molding substantially dissolves during a pre-wash cycle of a dish or clothes washer and the rest of the tablet substantially dissolves during a main wash cycle of a dish or clothes washer.

15. The laundry detergent or cleaning composition tablet as claimed in claim 13, characterized in that the separately produced molding has a top face which is not entirely planar.

16. The laundry detergent or cleaning composition tablet as claimed in claim 15, characterized in that the top face of the separately produced molding has convex curvature, the edge of the top face of the separately produced molding preferably being aligned parallel to the bottom face of the laundry detergent or cleaning composition tablets.

17. A laundry detergent or cleaning composition tablet, characterized in that the tablet has a bottom face and a top face, the two faces not being plane-parallel over at least half of the size of the smaller face and that the non-plane portions of the bottom face and top face form with one another an angle of from 10 to 500.

18. The laundry detergent or cleaning composition tablet as claimed in claim 17, characterized in that the tablet has a multilayer structure.

19. The laundry detergent or cleaning composition tablet as claimed in claim 17, characterized in that the top face has at least one cavity into which a separately produced molding can be introduced.

20. The laundry detergent or cleaning composition tablet as claimed in claim 19, characterized in that the separately produced molding substantially dissolves during a pre-wash cycle of a dish or clothes washer and the tablet substantially dissolves during a main wash cycle of a dish or clothes washer.
